(19) United States
(12) Patent Application Publication
(10) Pub. No.: US 2026/0091533 A1
(43) Pub. Date: Apr. 2, 2026

(54) A MOLD FOR PRODUCING AN ARTICLE OF MANUFACTURE

(71) Applicant: CRIATERRA INNOVATIONS LTD, Holon (IL)

(72) Inventors: Adital ELA, Bnei Zion (IL); Zvi COHEN, Haifa (IL); Lior NAHUM; Abraham DROR, Hadera (IL)

(21) Appl. No.: 19/110,419

(22) PCT Filed: Sep. 12, 2023
(86) PCT No.: PCT/IL2023/050985

§ 371 Date: Mar. 10, 2025

Related U.S. Application Data
(60) Provisional application No. 63/375,360, filed on Sep. 12, 2022.

(51) Int. Cl. B28B 7/00

(52) U.S. Cl. CPC B28B 7/0058; B28B 7/0097

(57) ABSTRACT

A mold for producing an article of manufacture from a mixture comprising liquid, said mold comprising: a pressing layer having a pressing layer front surface configured to press the mixture and extract the liquid therefrom, and an opposite pressing layer back surface a backing plate having a backing plate front surface facing the pressing layer back surface and an opposite backing plate back surface; and a liquid accumulating space extending at least partially in a plane parallel to the pressing layer and positioned between the backing plate back surface and the pressing layer front surface, the liquid accumulating space being configured to accumulate the liquid therein.

### TECHNICAL FIELD

The presently disclosed subject matter relates to molds for producing articles of manufacture, and more particularly to molds for producing articles of manufacture from mixtures containing liquid, and methods thereof.

### BACKGROUND

The building materials industry and the industry of interior design finishing products are controlled by conventional cement, quick lime, gypsum and burned clay. The methods of producing those materials, and thus the products based on those materials such as concrete, are one of the most environmental polluting processes in the industrial world. Thus, use of naturally existing materials as a raw material, especially natural binder that doesn't need firing and chemical alternation, for making Bio-Geo agglomerated stone, bricks, blocks, tiles, claddings and other pre-cast products have emerged as probable solution. Such mixtures contain a volume of liquid, most commonly water, therewithin that needs to be extracted and/or dried off from the mixtures during compression, for producing articles of manufacture. The efficiency of the process of extraction of liquid/water is the major challenge in order to achieve high mechanical properties through the final product.

### GENERAL DESCRIPTION

The presently disclosed subject matter relates to molds and processes for producing articles of manufacture from a mixture containing liquid/water. The mixture is processed within the molds at high pressure and temperature to produce a final product, which is high in strength and has uniform properties, such as density, throughout the final product. The processing includes pressing the mixture in a pressing mechanism and subjecting the mixture to high pressure and temperature simultaneously during pressing to extract the liquid therefrom. The molds are designed so as to extract and discharge the liquid in an effective and efficient manner to make the whole process efficient as well as effective for producing a product having uniform properties throughout.

According to a first aspect of the presently disclosed subject matter there is provided a mold for producing an article of manufacture from a mixture comprising liquid, said mold comprising: a pressing layer having a pressing layer front surface configured to press the mixture and extract the liquid therefrom, and an opposite pressing layer back surface; a backing plate having a backing plate front surface facing the pressing layer back surface and an opposite backing plate back surface; and a liquid accumulating space extending at least partially in a plane parallel to the pressing layer and positioned between the backing plate back surface and the pressing layer front surface, the liquid accumulating space being configured to accumulate the liquid therein.

The pressing layer can constitute a first pressing layer and the mold can further comprise a second pressing layer. The first and second pressing layers can constitute a pressing mechanism configured to receive the mixture therewithin and press the mixture to extract the liquid therefrom. The mold can further comprise a press member operatively coupled to the pressing mechanism and configured to operate the pressing mechanism for pressing the mixture. The mold can further comprise a biasing mechanism configured to continuously bias the pressing mechanism in a first direction to pressurize the mixture and compensate for a pressure drop in the mixture due to the extraction of the liquid.

According to a second aspect of the presently disclosed subject matter there is provided a mold for producing an article of manufacture from a mixture comprising a liquid, said mold comprising: a pressing mechanism configured to receive the mixture therewithin and press the mixture to extract the liquid therefrom; a press member operatively coupled to the pressing mechanism and configured to operate the pressing mechanism for pressing the mixture; and a biasing mechanism configured to continuously bias the pressing mechanism in a direction to pressurize the mixture and compensate for a pressure drop in the mixture due to said extraction of the liquid.

The pressing mechanism can comprise a first pressing layer and a second pressing layer and the press member can be configured to move at least one of the first and second pressing layers towards other one of the first and second pressing layers during said operation of the pressing mechanism.

In some examples, at least one of the first and second pressing layers can be a pressing layer having a pressing layer front surface configured to press the mixture and extract the liquid therefrom, and an opposite pressing layer back surface. The mold can further comprise a backing plate having a backing plate front surface facing the pressing layer back surface and an opposite backing plate back surface, and a liquid accumulating space extending at least partially in a plane parallel to the pressing layer and positioned between the backing plate back surface and the pressing layer front surface, the liquid accumulating space being configured to accumulate the liquid therein.

It is to be understood herein that the liquid accumulating space extending in a plane parallel to the pressing layer intends to mean that the liquid accumulating space is spread along a plane extending parallel to an area covered by the pressing layer. In other words, the liquid accumulating space occupies an area along the plane parallel to the pressing layer which is substantially and significantly more than an area that would be occupied by a conduit, pipe, a network of pipes and conduits, or channels configured to drain out the liquid from the pressing layer. In yet other words, it is to be understood herein that the liquid accumulating space is configured to hold a volume of liquid significantly more than what a conduit, pipe, a network of pipes and conduits, or channels configured to drain out the liquid would be generally configured to hold.

The liquid accumulating space can constitute a part of either or both the pressing layer and the backing plate, or can be positioned between the pressing layer and the backing plate. In some examples, the mold can further comprise an intermediate plate between the pressing layer and the backing plate and the liquid accumulating space can constitute a part of the intermediate plate.

Thus, the pressing layer(s), backing plate, and liquid accumulating space of the molds according to any one or both of the first and second aspects can include one or more of the following features:
Optionally, the pressing layer can be a solid pressing plate and the liquid can flow into the liquid accumulating space from a periphery of the solid pressing plate through a gap between the periphery and a frame of the mold.
Optionally, the pressing layer can be a liquid permeable pressing layer comprising a plurality of pores to allow the liquid to permeate through the liquid permeable pressing layer, wherein a combined cross-sectional area of the pores at a cross-section taken parallel to the pressing layer front surface can be smaller than a cross-sectional area of the liquid accumulating space at a cross-section taken parallel to the pressing layer front surface. In other words, if there are X number of pores on the pressing layer front surface and each pore occupy an area Y, then the total area X*Y can be lesser than the area occupied by the liquid accumulating space in a plane parallel to the pressing layer front surface. The liquid permeability can be achieved by an interconnected network of pores through the respective plate, and the total area occupied by the pores at a virtual plane parallel to the pressing layer front surface can be lesser than the area occupied by the liquid accumulating space in a virtual plane passing through the liquid accumulating space and parallel to the pressing layer front surface.
Optionally, the liquid accumulating space can extend under at least a majority of area of the pressing layer front surface. The liquid accumulating space can extend over at least a majority of area of the backing plate back surface. The liquid accumulating space can extend along at least 30%, at least 40%, at least 60%, at least 70%, at least 80%, at least 90% of area covered by either or all of the pressing layer front surface, pressing layer back surface, backing plate front surface, and backing plate back surface.
Optionally, the liquid accumulating space can constitute a part of at least one of the backing plate and the pressing layer.
Optionally, the liquid accumulating space can be constituted by a random space between the pressing plate front surface and the backing plate back surface.
Optionally, the liquid accumulating space can be constituted at least partially by one or more liquid accumulating channels formed on at least one of the backing plate front surface and the pressing layer back surface. The liquid accumulating space can be constituted at least partially by one or more liquid accumulating channels formed on the intermediate plate.
Optionally, the backing plate and the pressing layer can be spaced from each other to at least partially define therebetween the liquid accumulating space. The mold can comprise one or more spacer elements positioned at least partially within the liquid accumulating space. One or more of the spacer elements can be formed integrally with either of the backing plate and the pressing layer.
Optionally, the liquid accumulating space can be large enough to accumulate the liquid extracted during production of a number of articles, and then can be emptied during maintenance of the mold or by drying off of the liquid naturally.
Optionally, the mold can include one or more drainage channels in fluid communication with the liquid accumulating space for draining out the liquid therefrom.
Optionally, at least one of the one or more drainage channels can be at least partially positioned within the backing plate.
Optionally, the liquid accumulating space can be divided into a plurality of regions. At least one of the plurality of regions can be in fluid communication with at least another of the plurality of regions. Each of the plurality of regions can be in fluid communication with at least one of the one or more drainage channels.
Optionally, the liquid can be drained out from the liquid accumulating space using a suction mechanism, which may or may not be a part of the mold. The suction mechanism can be fluidly connected to the liquid accumulating space through the drainage channels and/or separate suction channels.

The molds according to any one or both of the first and second aspects can include one or more of following features:
Optionally, the mold can further comprise a fixing mechanism for fixing the backing plate and the pressing layer together with each other. The fixing mechanism can comprise one or more fixing elements protruding from at least one of the backing plate and the pressing layer and one or more recesses corresponding said one or more fixing elements formed on at least another of the backing plate and the pressing layer, each configured to receive therein a respective fixing element to facilitate assembly of the pressing layer with the backing plate. Optionally, the fixing mechanism can fix the backing plate and the pressing layer detachably. In some examples, the recesses can be configured to removably receive therewithin the corresponding fixing elements.
Optionally, the mold can further comprise a separating mechanism for separating the pressing layer from the backing plate. In some examples, the separating mechanism can bias the pressing layer away from the backing plate. In some examples, the separating mechanism can be configured to maintain a gap between at least a portion of the pressing layer and at least a portion of the backing plate, thereby separating the pressing layer from the backing plate, at least prior to initiation of operation of the mold and at least after completion of operation of the mold. In some examples, the pressing layer can be removable from the mold, and/or the portion of the pressing layer can be configured to be held by a user for detaching the pressing layer from the backing plate and/or for removing the pressing layer from the mold.
Optionally, the mold can further comprise a heating mechanism configured to heat the mixture and assist in the extraction of the liquid therefrom. The heating mechanism can be configured to heat the pressing layer, and thus the mixture. The heating mechanism can be at least partially positioned within, embedded within, or integrally formed with the backing plate. The heating mechanism can be a fluid heating mechanism and can comprise heating channels extending at least partially within the backing plate and configured to facilitate flow of heating fluid therein. The backing plate can be in heat communication with the pressing layer to conduct heat from the heating mechanism to the pressing layer.

The pressing layer(s) and backing plate of the molds according to any one or both of the first and second aspects can include one or more of the following features:
Optionally, the pressing layer can comprise a first capillary fabric configured to contact the mixture for absorbing the liquid therefrom and delivering the liquid to the liquid accumulating space. The capillary fabric can be positioned either directly on the backing plate or on an intermediate plate that can be either a solid plate or a liquid permeable plate.
Optionally, the pressing layer can comprise a liquid permeable pressing plate. The backing plate can be in contact with the liquid permeable pressing plate and provides structural support to the liquid permeable pressing plate. The backing plate can be in contact with the liquid permeable pressing plate at least at a periphery thereof thereby sealing the liquid accumulating space at said periphery. The liquid permeable pressing plate is a porosive plate with size of pores is in microns grade. The liquid permeable pressing plate and/or the backing plate can be rigid.
Optionally, the second pressing layer can have some or all of the features of the pressing layer or the first pressing layer described above. In other words, either or both of the pressing layers can have some or all of the featured described above with respect to the pressing layer.
Optionally, the pressing layer can be configured to be positioned at an angle with respect to a pressing direction, i.e., the direction of operation of the press member. In some examples, the angle can be equal to 0 or 90, or can be between 0 and 90.
Optionally, the pressing layer can comprise one or more mixture receiving portions for receiving thereupon the mixture, and in some examples, at least one of the one or more mixture receiving portions can comprise a cavity formed in the pressing layer front surface.

The liquid accumulation space providing a facility to hold the liquid eliminates the need for continuous drainage through conduits laid directly from the pressing mechanism to an exterior of the mold. Such conduits being narrow in cross-section can get blocked by small parts of mixture that flow along with the liquid thereby blocking the drainage of the liquid and affecting the efficiency of the mold. The possibility of accumulating a certain volume of the liquid (at least temporarily) rather than continuously draining it out through conduits only provides a tolerance with the blockages and/or reduced flow rates in the drainage channels (or conduits), thereby rendering the whole process of removing the liquid more efficient. Additionally, the liquid accumulating space being spread in an area facilitates more flexibility for positioning of the drainage channels in such a manner to have least number of bends thereby resulting in reduced chances of blockages and/or reduced flow rates. Moreover, a reduced number of drainage channels can drain out the liquid as compared to the number of channels that are required to drain the same volume of liquid with same efficiency without the liquid accumulating space being spread along an area, thereby reducing the costs involved. The reduced number of drainage channels facilitates more space within the backing plate for placement of the heating mechanism, suction channels, etc, thereby resulting in a compact mold. Moreover, the drainage channels can be reduced in size so that it blocks the particles in the mixture inside the mold, above the pressing surface of the pressing layers. The accumulation space compensates for the slow drainage through such small drainage channels, thus resulting in an overall improved drainage efficiency even with small drainage channels. The reduction in size of the drainage channels further facilitates more space within the backing plate for placement of the heating mechanism, suction channels, etc, thereby resulting in a compact mold.

The pressing mechanism, press member, and biasing mechanism of the molds according to any one or both of the first and second aspects can include one or more of the following features:
Optionally, the biasing mechanism can comprise a spring operatively coupled to said at least one of the first and second pressing layers.
Optionally, the press member can be configured to load the spring in a second direction opposite said first direction during said operation of the pressing mechanism.
Optionally, the press member can be configured to move at least one of the first and second pressing layers towards other one of the first and second pressing layers during said operation of the pressing mechanism.

The biasing mechanism effects in a final product having uniform physical properties, especially density, throughout. For instance, the biasing mechanism does not allow the mixture to experience a pressure drop therewithin during the whole process and thus results in a uniform final product.

The molds according to any one or both of the first and second aspects can further include one or more of following features:
Optionally, the backing plate can constitute a first backing plate, the mold can further comprise a second backing plate having a second backing plate front surface facing the second pressing layer back surface and an opposite second backing plate back surface, wherein the second pressing layer can be fixed to the second backing plate. In some examples, the second pressing layer can be detachably fixed to the second backing plate.
Optionally, the liquid accumulating space can constitute a first liquid accumulating space, the mold can further comprise a second liquid accumulating space extending at least partially in a plane parallel to the second pressing layer and positioned between the second backing plate back surface and the second pressing layer front surface.
Optionally, the pressing mechanism can constitute a first pressing mechanism, the mold can further comprise a second pressing mechanism configured to receive a second mixture. The second mixture can be different from the first mixture, including same (but prepared separately) or different contents, or can be a another portion of the first mixture.
Optionally, the press member can be configured to operate the second pressing mechanism simultaneously with the first pressing mechanism.
Optionally, the mold can further comprise a third pressing layer at least partially constituting the second pressing mechanism.
Optionally, the third pressing layer can have a third pressing layer front surface for pressing the second mixture and an opposite third pressing layer back surface, the mold can further comprise a third backing plate having a third backing plate front surface facing the third pressing layer back surface and an opposite third backing plate front surface, the mold can further comprise a third liquid accumulating space positioned between the third backing plate back surface and the third pressing layer front surface.
Optionally, the second pressing mechanism can be constituted by the third pressing layer and the second backing plate back surface.
Optionally, the mold can further comprise a third pressing mechanism configured to receive a third mixture.
Optionally, the mold can further comprise an ejecting mechanism configured to bias the pressing layer towards a third direction extending from the pressing layer back surface towards the pressing layer front surface.
Optionally, the pressing layer constitutes a bottom pressing layer configured to receive thereon the mixture, said mold further comprising a frame at least partially surrounding the pressing layer peripherally, said frame comprising a frame front surface, wherein the frame front surface and the pressing layer front surface face in the same direction.
Optionally, the ejecting mechanism can be configured to position the pressing layer front surface further from the frame front surface towards the third direction.
Optionally, the ejecting mechanism can comprise one or more springs configured to bias the pressing layer front surface further from the frame front surface in the third direction.
Optionally, the ejecting mechanism can be assisted by back air pressure injected through the drainage channels.
Optionally, the pressing layer front surface can be polished down to #1200 grid (up to mirror like finish) to reduce the adherence of the material to the mold and to ease on the ejecting process.
Optionally, the pressing layer front surface can be coated after polish, so that the coating will reduce the adherence of the material to the mold and to ease on the ejecting process. The coating must be a permeable coating that does not block the water drainage through the pressing layer. One example of the coating can be a diffusion coating.

### EMBODIMENTS

A more specific description is provided in the Detailed Description whilst the following are non-limiting examples of different embodiments of the presently disclosed subject matter. It should be appreciated that Embodiments 1 to 71 correspond to the first aspect of the presently disclosed subject matter and Embodiments 72 to 136 correspond to the second aspect of the presently disclosed subject matter.
1. A mold for producing an article of manufacture from a mixture comprising liquid, said mold comprising:
   a pressing layer having a pressing layer front surface configured to press the mixture and extract the liquid therefrom, and an opposite pressing layer back surface;
   a backing plate having a backing plate front surface facing the pressing layer back surface and an opposite backing plate back surface; and a liquid accumulating space extending at least partially in a plane parallel to the pressing layer and positioned between the backing plate back surface and the pressing layer front surface, the liquid accumulating space being configured to accumulate the liquid therein.
2. The mold according to Embodiment 1, wherein the pressing layer is a liquid permeable pressing layer comprising a plurality of pores to allow the liquid to permeate through the liquid permeable pressing layer, wherein a combined cross-sectional area of the pores at a cross-section taken parallel to the pressing layer front surface is smaller than a cross-sectional area of the liquid accumulating space at a cross-section taken parallel to the pressing layer front surface.
3. The mold according to Embodiment 1 or 2, wherein the liquid accumulating space extends under at least a majority of area of the pressing layer front surface.
4. The mold according to any one of the embodiments 1 to 3, wherein the liquid accumulating space extends over at least a majority of area of the backing plate back surface.
5. The mold according to any one of embodiments 1 to 4, wherein the liquid accumulating space constitutes a part of at least one of the backing plate and the pressing layer.
6. The mold according to any one of embodiments 1 to 5, wherein the liquid accumulating space is constituted at least partially by one or more liquid accumulating channels formed on at least one of the backing plate front surface and the pressing layer back surface.
7. The mold according to any one of embodiments 1 to 6, further comprising an intermediate plate positioned between the backing plate and the pressing layer, wherein the liquid accumulating space is constituted at least partially by one or more liquid accumulating channels formed on the intermediate plate.
8. The mold according to any one of embodiments 1 to 7, wherein the backing plate and the pressing layer are spaced from each other to at least partially define therebetween the liquid accumulating space.
9. The mold according to Embodiment 8, further comprising one or more spacer elements positioned at least partially within the liquid accumulating space.
10. The mold according to Embodiment 9, wherein the spacer elements are formed integrally with either of the backing plate and the pressing layer.
11. The mold according to any one of embodiments 1 to 10, further comprising one or more drainage channels in fluid communication with the liquid accumulating space for draining out the liquid therefrom.
12. The mold according to Embodiment 11, wherein at least one of the one or more drainage channels is at least partially positioned within the backing plate.
13. The mold according to any one of embodiments 1 to 12, wherein the liquid accumulating space is divided into a plurality of regions.
14. The mold according to Embodiment 13, wherein at least one of the plurality of regions is in fluid communication with at least another of the plurality of regions.
15. The mold according to Embodiment 13 or 14, when dependent on Embodiment 11, wherein each of the plurality of regions is in fluid communication with at least one of the one or more drainage channels.
16. The mold according to any one of embodiments 1 to 15, further comprising a fixing mechanism for fixing the backing plate and the pressing layer together with each other.
17. The mold according to Embodiment 16, wherein the fixing mechanism fixes the backing plate and the pressing layer detachably.
18. The mold according to Embodiment 17, wherein the pressing layer is removable from the mold.
19. The mold according to any one of embodiments 16 to 18, wherein the fixing mechanism comprises one or more fixing elements protruding from at least one of the backing plate and the pressing layer and one or more recesses corresponding said one or more fixing elements formed on at least another of the backing plate and the pressing layer, each configured to receive therein a respective fixing element to facilitate assembly of the pressing layer with the backing plate.
20. The mold according to Embodiment 19, wherein the recesses are configured to removably receive therewithin the corresponding fixing elements.
21. The mold according to any one of embodiments 1 to 20, further comprising a separating mechanism for separating the pressing layer from the backing plate.
22. The mold according to Embodiment 21, wherein the separating mechanism biases the pressing layer away from the backing plate.
23. The mold according to Embodiment 20 or 21, wherein the separating mechanism is configured to maintain a gap between at least a portion of the pressing layer and at least a portion of the backing plate, thereby separating the pressing layer from the backing plate, at least prior to initiation of operation of the mold and at least after completion of operation of the mold.
24 The mold according to Embodiment 23, said portion of the pressing layer being configured to be held by a user for detaching the pressing layer from the backing plate and/or for removing the pressing layer from the mold.
25. The mold according to any one of embodiments 1 to 24, further comprising a heating mechanism configured to heat the mixture and assist in the extraction of the liquid.
26. The mold according to Embodiment 25, wherein the heating mechanism is configured to heat the pressing layer.
27. The mold according to Embodiment 25 or 26, wherein the heating mechanism is at least partially positioned within the backing plate.
28. The mold according to any one of embodiments 25 to 27, wherein the heating mechanism is at least partially embedded within the backing plate.
29. The mold according to Embodiment 27 or 28, wherein the heating mechanism is at least partially integrally formed with the backing plate.
30. The mold according to any one of embodiments 27 to 29, wherein the heating mechanism is a fluid heating mechanism and comprises heating channels extending at least partially within the backing plate and configured to facilitate flow of heating fluid therein.
31. The mold according to any one of embodiments 27 to 30, wherein the backing plate is in heat communication with the pressing layer to conduct heat from the heating mechanism to the pressing layer.
32. The mold according to any one of embodiments 1 to 31, further comprising a suction mechanism in fluid communication with the liquid accumulating space and configured to assist in drainage of liquid therefrom.
33. The mold according to Embodiment 32, when dependent on Embodiment 11, wherein the suction mechanism is in fluid communication with at least one of the one or more drainage channels.
34. The mold according to any one of embodiments 1 to 33, wherein the pressing layer comprises a first capillary fabric configured to contact the mixture for absorbing the liquid therefrom and delivering the liquid to the liquid accumulating space.
35. The mold according to any one of embodiments 1 to 34, wherein the pressing layer comprises a first liquid permeable pressing plate.
36. The mold according to Embodiment 35, wherein the backing plate is in contact with the first liquid permeable pressing plate and provides structural support to the first liquid permeable pressing plate.
37. The mold according to Embodiment 36, wherein the backing plate is in contact with the first liquid permeable pressing plate at least at a periphery thereof thereby sealing the liquid accumulating space at said periphery.
38. The mold according to any one of embodiments 35 to 37, wherein the first liquid permeable pressing plate is a porosive plate.
39. The mold according to Embodiment 38, wherein size of pores is in microns grade.
40. The mold according to any one of embodiments 35 to 39, wherein the first liquid permeable pressing plate is rigid.
41. The mold according to any one of embodiments 1 to 40, wherein the backing plate is rigid.
42. The mold according to any one of embodiments 1 to 41, wherein the pressing layer at least partially constitutes a pressing mechanism configured to receive the mixture therewithin, the mold further comprising a press member operatively coupled to the pressing mechanism and configured to operate the pressing mechanism for pressing the mixture along a pressing direction, said pressing mechanism being configured to extract the liquid from the mixture at least during said pressing thereof.
43. The mold according to Embodiment 42, wherein the pressing layer is configured to be positioned at an angle with respect to the pressing direction.
44. The mold according to Embodiment 43, wherein angle is equal to 90.
45. The mold according to Embodiment 43, wherein angle is equal to 0.
46. The mold according to Embodiment 43, wherein angle is between 0 and 90.
47. The mold according to any one of embodiments 1 to 44, wherein the pressing layer constitutes a first pressing layer, said mold further comprising a second pressing layer having a second pressing layer front surface configured to press the mixture and extract the liquid therefrom, and an opposite second pressing layer back surface, said first and second pressing layers constituting the pressing mechanism.
48. The mold according to Embodiment 47, further comprising a biasing mechanism configured to continuously bias the pressing mechanism in a first direction to pressurize the mixture and compensate for a pressure drop in the mixture due to said extraction of the liquid.
49. The mold according to Embodiment 48, wherein the biasing mechanism is configured to continuously bias at least one of the first and second pressing layers towards other one of the first and second pressing layers at least during operation of the mold.
50. The mold according to Embodiment 49, wherein the biasing mechanism comprises a spring operatively coupled to said at least one of the first and second pressing layers.
51. The mold according to Embodiment 50, wherein the press member is configured to load the spring in a second direction opposite said first direction during said operation of the pressing mechanism.
52. The mold according to any one of embodiments 47 to 51, wherein the press member is configured to move at least one of the first and second pressing layers towards other one of the first and second pressing layers during said operation of the pressing mechanism.
53. The mold according to any one of embodiments 47 to 52, wherein the second pressing layer is configured to allow the liquid to flow therethrough.
54. The mold according to Embodiment 53, wherein the second pressing layer comprises a second capillary fabric configured to contact the mixture for absorbing the liquid.
55. The mold according to Embodiment 53 or 54, wherein the second pressing layer comprises a second liquid permeable pressing plate.
56. The mold according to Embodiment 55, wherein the second liquid permeable pressing plate is a porosive plate.
57. The mold according to any one of embodiments 1 to 56, wherein the pressing layer comprises one or more mixture receiving portions for receiving thereupon the mixture.
58. The mold according to Embodiment 57, wherein at least one of the one or more mixture receiving portions comprises a cavity formed in the pressing layer front surface.
59. The mold according to any one of embodiments 47 to 57, wherein the backing plate constitutes a first backing plate, said mold further comprising a second backing plate having a second backing plate front surface facing the second pressing layer back surface and an opposite second backing plate back surface, wherein the second pressing layer is fixed to the second backing plate.
60. The mold according to Embodiment 59, wherein the second pressing layer is detachably fixed to the second backing plate.
61. The mold according to Embodiment 59 or 60, wherein the liquid accumulating space constitutes a first liquid accumulating space, said mold further comprising a second liquid accumulating space extending at least partially in a plane parallel to the second pressing layer and positioned between the second backing plate back surface and the second pressing layer front surface.
62. The mold according to any one of embodiments 47 to 61, wherein the pressing mechanism constitutes a first pressing mechanism, said mold further comprising a second pressing mechanism configured to receive a second mixture.
63. The mold according to Embodiment 62, when dependent on Embodiment 42, wherein the press member is configured to operate the second pressing mechanism simultaneously with the first pressing mechanism.
64. The mold according to Embodiment 62 or 63, further comprising a third pressing layer at least partially constituting the second pressing mechanism.
65. The mold according to Embodiment 64, when dependent on Embodiment 61, the third pressing layer having a third pressing layer front surface for pressing the second mixture and an opposite third pressing layer back surface, said mold further comprising a third backing plate having a third backing plate front surface facing the third pressing layer back surface and an opposite third backing plate front surface, said mold further comprising a third liquid accumulating space positioned between the third backing plate back surface and the third pressing layer front surface.
66. The mold according to Embodiment 64 or 65, when dependent on Embodiment 59, wherein the second pressing mechanism is constituted by the third pressing layer and the second backing plate back surface.
67. The mold according to Embodiment 62 or any one of embodiments 63 to 66, when dependent on Embodiment 62, further comprising a third pressing mechanism configured to receive a third mixture.
68. The mold according to any one of embodiments 1 to 67, further comprising an ejecting mechanism configured to bias the pressing layer towards a third direction extending from the pressing layer back surface towards the pressing layer front surface.
69. The mold according to any one of embodiments 1 to 68, wherein the pressing layer constitutes a bottom pressing layer configured to receive thereon the mixture, said mold further comprising a frame at least partially surrounding the pressing layer peripherally, said frame comprising a frame front surface, wherein the frame front surface and the pressing layer front surface face in the same direction.
70. The mold according to Embodiment 69, when dependent on Embodiment 68, wherein the ejecting mechanism is configured to position the pressing layer front surface further from the frame front surface towards the third direction.
71. The mold according to Embodiment 70, wherein the ejecting mechanism comprises one or more springs configured to bias the pressing layer front surface further from the frame front surface in the third direction.
72. A mold for producing an article of manufacture from a mixture comprising a liquid, said mold comprising:
   a pressing mechanism configured to receive the mixture therewithin and press the mixture to extract the liquid therefrom;
   a press member operatively coupled to the pressing mechanism and configured to operate the pressing mechanism for pressing the mixture; and
   a biasing mechanism configured to continuously bias the pressing mechanism in a direction to pressurize the mixture and compensate for a pressure drop in the mixture due to said extraction of the liquid.
73. The mold according to Embodiment 72, wherein the pressing mechanism comprises a first pressing layer and a second pressing layer, the press member being configured to move at least one of the first and second pressing layers towards other one of the first and second pressing layers during said operation of the pressing mechanism.
74. The mold according to Embodiment 73, wherein the biasing mechanism is configured to continuously bias at least one of the first and second pressing layers towards other one of the first and second pressing layers at least during operation of the mold.
75. The mold according to Embodiment 74, wherein the biasing mechanism comprises a spring operatively coupled to said at least one of the first and second pressing layers.
76. The mold according to Embodiment 75, wherein the press member is configured to load the spring in a second direction opposite said first direction during said operation of the pressing mechanism.
77. The mold according to any one of embodiments 72 to 76, further comprising a heating mechanism configured to heat the mixture and assist in the extraction of the liquid.
78. The mold according to Embodiment 77, wherein the heating mechanism is configured to heat at least one of the first and second pressing plates.
79. The mold according to any one of embodiments 72 to 78, further comprising one or more drainage channels configured to drain out the liquid from the mold.
80. The mold according to any one of embodiments 72 to 79, further comprising a suction mechanism configured to assist in drainage of the liquid from the mold.
81. The mold according to Embodiment 80, when dependent on Embodiment 79, wherein the suction mechanism is in fluid communication with at least one of the one or more drainage channels.
82. The mold according to Embodiment 73 or any one of embodiments 74 to 81 when dependent on Embodiment 73, wherein at least one of the first and second pressing layers is a pressing layer having a pressing layer front surface configured to press the mixture and extract the liquid therefrom, and an opposite pressing layer back surface.
83. The mold according to Embodiment 82, further comprising:
   a backing plate having a backing plate front surface facing the pressing layer back surface and an opposite backing plate back surface; and
   a liquid accumulating space extending at least partially in a plane parallel to the pressing layer and positioned between the backing plate back surface and the pressing layer front surface, the liquid accumulating space being configured to accumulate the liquid therein.
84. The mold according to Embodiment 83, wherein the pressing layer is a liquid permeable pressing layer comprising a plurality of pores to allow the liquid to permeate through the pressing layer front surface, wherein a combined cross-sectional area of the pores at a cross-section taken parallel to the liquid permeable pressing layer is smaller than a cross-sectional area of the liquid accumulating space at a cross-section taken parallel to the pressing layer front surface.
85. The mold according to Embodiment 83 or 84, wherein the liquid accumulating space extends under at least a majority of area of the pressing layer front surface.
86. The mold according to any one of the embodiments 83 to 85, wherein the liquid accumulating space extends over at least a majority of area of the backing plate back surface.
87. The mold according to any one of embodiments 83 to 86, wherein the liquid accumulating space constitutes a part of at least one of the backing plate and the pressing layer.
88. The mold according to any one of embodiments 83 to 87, wherein the liquid accumulating space is constituted at least partially by one or more liquid accumulating channels formed on at least one of the backing plate front surface and the pressing layer back surface.
89. The mold according to any one of embodiments 83 to 88, further comprising an intermediate plate positioned between the backing plate and the pressing layer, wherein the liquid accumulating space is constituted at least partially by one or more liquid accumulating channels formed on the intermediate plate.
90. The mold according to any one of embodiments 83 to 89, wherein the backing plate and the pressing layer are spaced from each other to at least partially define therebetween the liquid accumulating space.
91. The mold according to Embodiment 90, further comprising one or more spacer elements positioned at least partially within the liquid accumulating space.
92. The mold according to Embodiment 91, wherein the spacer elements are formed integrally with either of the backing plate and the pressing layer.
93. The mold according to any one of embodiments 83 to 92, when dependent on Embodiment 79, wherein at least one of said one or more drainage channels is in fluid communication with the liquid accumulating space for draining out the liquid therefrom.
94. The mold according to Embodiment 93, wherein at least one of the one or more drainage channels is at least partially positioned within the backing plate.
95. The mold according to any one of embodiments 83 to 94, wherein the liquid accumulating space is divided into a plurality of regions.
96. The mold according to Embodiment 95, wherein at least one of the plurality of regions is in fluid communication with at least another of the plurality of regions.
97. The mold according to Embodiment 95 or 96, when dependent on Embodiment 93, wherein each of the plurality of regions is in fluid communication with at least one of the one or more drainage channels.
98. The mold according to any one of embodiments 83 to 97, further comprising a fixing mechanism for fixing the backing plate and the pressing layer together with each other.
99. The mold according to Embodiment 98, wherein the fixing mechanism fixes the backing plate and the pressing layer detachably.
100. The mold according to Embodiment 99, wherein the pressing layer is removable from the mold.
101. The mold according to any one of embodiments 98 to 100, wherein the fixing mechanism comprises one or more fixing elements protruding from at least one of the backing plate and the pressing layer and one or more recesses corresponding said one or more fixing elements formed on at least another of the backing plate and the pressing layer, each configured to receive therein a respective fixing element to facilitate assembly of the liquid permeable pressing layer with the backing plate.
102. The mold according to Embodiment 101, wherein the recesses are configured to removably receive therewithin the corresponding fixing elements.
103. The mold according to any one of embodiments 83 to 102, further comprising a separating mechanism for separating the pressing layer from the backing plate.
104. The mold according to Embodiment 103, wherein the separating mechanism biases the pressing layer away from the backing plate.
105. The mold according to Embodiment 103 or 104, wherein the separating mechanism is configured to maintain a gap between at least a portion of the pressing layer and at least a portion of the backing plate, thereby separating the pressing layer from the backing plate, at least prior to initiation of operation of the mold and at least after completion of operation of the mold.
106. The mold according to Embodiment 105, said portion of the pressing layer being configured to be held by a user for detaching the pressing layer from the backing plate and/or for removing the pressing layer from the mold.
107. The mold according to any one of embodiments 83 to 106, when dependent on Embodiment 80, wherein the suction unit is in fluid communication with the liquid accumulating space.
108. The mold according to any one of embodiments 83 to 107, when dependent on Embodiment 77, wherein the heating mechanism is configured to heat the pressing layer.
109. The mold according to any one of embodiments 83 to 108, when dependent on Embodiment 77, wherein the heating mechanism is at least partially positioned within the backing plate.
110. The mold according to any one of embodiments 83 to 109, when dependent on Embodiment 77, wherein the heating mechanism is at least partially embedded within the backing plate.
111. The mold according to Embodiment 109 or 110, wherein the heating mechanism is at least partially integrally formed with the backing plate.
112. The mold according to any one of embodiments 109 to 111, wherein the heating mechanism is a fluid heating mechanism and comprises heating channels extending at least partially within the backing plate and configured to facilitate flow of heating fluid therein.
113. The mold according to any one of embodiments 109 to 112, wherein the backing plate is in heat communication with the pressing layer to conduct heat from the heating mechanism to the pressing layer.
114. The mold according to any one of embodiments 82 to 113, wherein the pressing layer comprises a first capillary fabric configured to contact the mixture for absorbing the liquid therefrom.
115. The mold according to any one of embodiments 82 to 114, wherein the pressing layer comprises a first liquid permeable pressing plate.
116. The mold according to Embodiment 115, when dependent on Embodiment 83, wherein the backing plate is in contact with the first liquid permeable pressing plate and provides structural support to the first liquid permeable pressing plate.
117. The mold according to Embodiment 116, wherein the backing plate is in contact with the first liquid permeable pressing plate at least at a periphery thereof thereby sealing the liquid accumulating space at said periphery.
118. The mold according to any one of embodiments 115 to 117, wherein the first liquid permeable pressing plate is a porosive plate.
119. The mold according to Embodiment 118, wherein size of pores is in microns grade.
120. The mold according to any one of embodiments 115 to 119, wherein the first liquid permeable pressing plate is rigid.
121. The mold according to Embodiment 83 or any one of embodiments 84 to 120 when dependent on Embodiment 83, wherein the backing plate is rigid.
122. The mold according to any one of embodiments 82 to 121, further comprising an ejecting mechanism configured to bias the pressing layer towards a third direction extending from the pressing layer back surface towards the pressing layer front surface.
123. The mold according to any one of embodiments 82 to 122, wherein the pressing layer constitutes a bottom pressing layer configured to receive thereon the mixture, said mold further comprising a frame at least partially surrounding the liquid permeable pressing layer peripherally, said frame comprising a frame front surface, wherein the frame front surface and the pressing layer front surface face in the same direction.
124. The mold according to Embodiment 123, when dependent on Embodiment 122, wherein the ejecting mechanism is configured to position the pressing layer front surface further from the frame front surface towards the third direction.
125. The mold according to Embodiment 124, wherein the ejecting mechanism comprises one or more springs configured to bias the pressing layer front surface further from the frame front surface in the third direction.
126. The mold according to Embodiment 83 or any one of embodiments 84 to 125 when dependent on Embodiment 59, wherein the pressing layer is constituted by the first pressing layer having a first pressing layer front surface for pressing the mixture and an opposite first pressing layer back surface, said second pressing layer having a second pressing layer front surface configured to press the mixture, and an opposite second pressing layer back surface.
127. The mold according to Embodiment 126, wherein the backing plate constitutes a first backing plate having a first backing plate front surface facing the first pressing layer back surface and an opposite first backing plate back surface, said mold further comprising a second backing plate having a second backing plate front surface facing the second pressing layer back surface and an opposite second backing plate back surface.
128. The mold according to Embodiment 127, wherein the liquid accumulating space constitutes a first liquid accumulating space, said mold further comprising a second liquid accumulating space extending at least partially in a plane parallel to the second pressing layer and positioned between the second backing plate back surface and the second pressing layer front surface.
129. The mold according to any one of embodiments 126 to 128, wherein the pressing mechanism constitutes a first pressing mechanism, said mold further comprising a second pressing mechanism configured to receive a second mixture.
130. The mold according to Embodiment 129, wherein the press member is configured to operate the second pressing mechanism simultaneously with the first pressing mechanism.
131. The mold according to Embodiment 129 or 130, further comprising a third pressing layer at least partially constituting the second pressing mechanism.
132. The mold according to Embodiment 131, when dependent on Embodiment 128, the third pressing layer having a third pressing layer front surface for pressing the second mixture and an opposite third pressing layer back surface, said mold further comprising a third backing plate having a third backing plate front surface facing the third pressing layer back surface and an opposite third backing plate front surface, said mold further comprising a third liquid accumulating space positioned between the third backing plate back surface and the third pressing layer front surface.
133. The mold according to Embodiment 131 or 132, when dependent on Embodiment 127, wherein the second pressing mechanism is constituted by the third pressing layer and the second backing plate back surface.
134. The mold according to Embodiment 129 or any one of embodiments 130 to 133, when dependent on Embodiment 129, further comprising a third pressing mechanism configured to receive a third mixture.
135. The mold according to Embodiment 82 or any one of embodiments 83 to 134, when dependent on Embodiment 82, wherein the pressing layer comprises one or more mixture receiving portions for receiving thereupon the mixture.
136. The mold according to Embodiment 135, wherein at least one of the one or more mixture receiving portions comprises a cavity formed in the pressing layer front surface.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1A is a top perspective view of a mold according to an example of the presently disclosed subject matter;

FIG. 1B is a bottom perspective view of the mold of FIG. 1A;

FIG. 1C is the same view as in FIG. 1A with a mixture placed within the mold prior to initiation of processing of the mixture;

FIG. 1D is a cross-sectional view taken along line A-A in FIG. 1C;

FIG. 1E is the same view as in FIG. 1C showing the mold during the processing of the mixture;

FIG. 1F is a cross-sectional view taken along line B-B in FIG. 1E;

FIG. 1G is the same view as in FIG. 1C showing the mold with a final product after completion of the processing;

FIG. 1H is a cross-sectional view taken along line C-C in FIG. 1G;

FIG. 1I is a cross-sectional view taken along line D-D in FIG. 1G;

FIG. 2A is another top perspective of the mold of FIG. 1A with upper part of the mold and press member removed for illustration purposes;

FIG. 2B is a partially exploded view of the mold shown in FIG. 2A with its first pressing layer disassembled;

FIG. 2C is a bottom perspective view of the mold as shown in FIG. 2B;

FIG. 2D is another partially exploded view of the mold shown in FIG. 2A with its first pressing layer and intermediate plate disassembled;

FIG. 2E is a cross-sectional view taken along line E-E in FIG. 2A;

FIG. 2F is a cross-sectional view taken along line F-F in FIG. 2B;

FIG. 2G is a cross-sectional view taken along line G-G in FIG. 2D;

FIG. 2H is a bottom perspective view of the first pressing layer of the mold of FIG. 2A;

FIG. 2I is a bottom view of the first pressing layer of FIG. 2H;

FIG. 3A is a top perspective view of a mold according to another example of the presently disclosed subject matter, shown at a state during processing of a mixture, with upper part of the mold, press member, and mixture removed for illustration purposes;

FIG. 3B is a partially exploded view of the mold shown in FIG. 3A with its first pressing layer disassembled;

FIG. 3C is another partially exploded view of the mold shown in FIG. 3A with its first pressing layer and intermediate plate disassembled;

FIG. 3D is an enlarged view of portion P1 of FIG. 3C;

FIG. 3E is a side perspective view of the mold of FIG. 3A;

FIG. 3F is a cross-sectional view taken along line H-H in FIG. 3A;

FIG. 3G is a cross-sectional view taken along line I-I in FIG. 3B;

FIG. 3H is an enlarged view of portion P2 of FIG. 3G;

FIG. 3I is a cross-sectional view taken along line J-J in FIG. 3C;

FIG. 3J is a top view of the intermediate plate of the mold of FIG. 3A;

FIG. 3K is a cross-sectional view taken along line K-K in FIG. 3A;

FIG. 4A is a top perspective view of a mold according to yet another example of the presently disclosed subject matter;

FIG. 4B is an exploded view of the bottom part of the mold of FIG. 4A;

FIG. 5A is a schematic view of a mold according to yet another example of the presently disclosed subject matter;

FIG. 5B is a schematic view of a mold according to yet another example of the presently disclosed subject matter;

FIG. 5C is a top perspective view of an arrangement of pressing mechanisms of a mold according to yet another example of the presently disclosed subject matter;

FIG. 5D is a cross-sectional view taken along line L-L in FIG. 5C;

FIG. 6A is a top perspective view of a mold according to yet another example of the presently disclosed subject matter;

FIG. 6B is a cross-sectional view taken along line M-M in FIG. 6A; and

FIG. 6C is an enlarged view of portion P3 of FIG. 6B.

### DETAILED DESCRIPTION

The following detailed description sets forth general and specific details about features of the molds according to various aspects and examples of the presently disclosed subject matter.

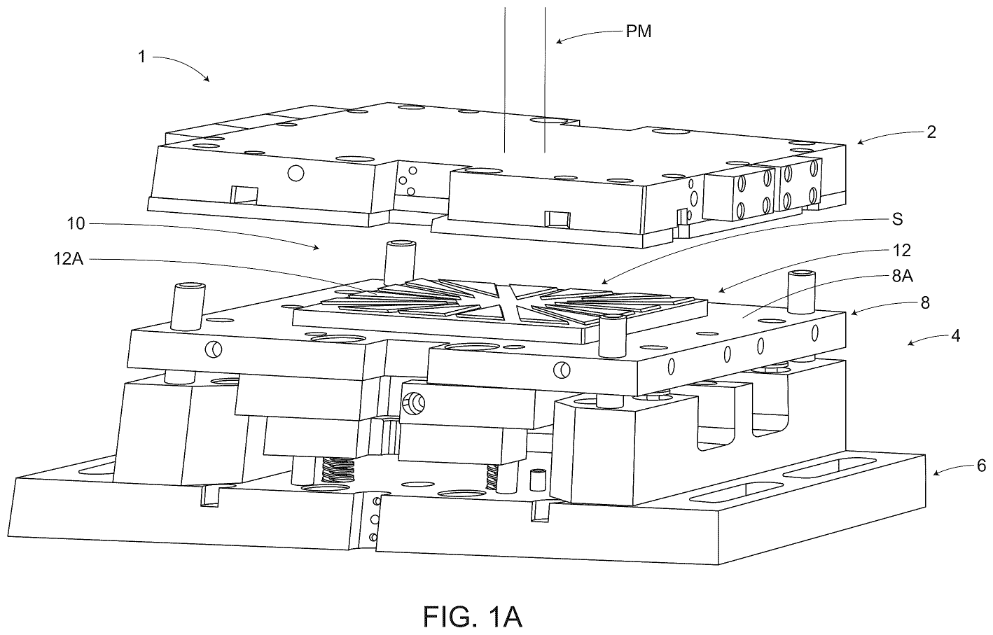

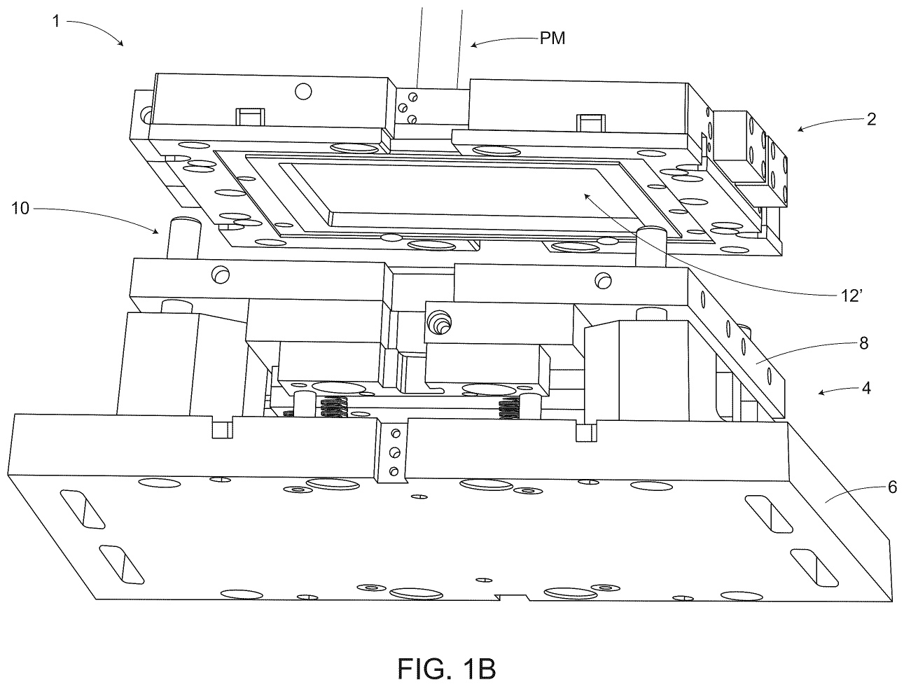

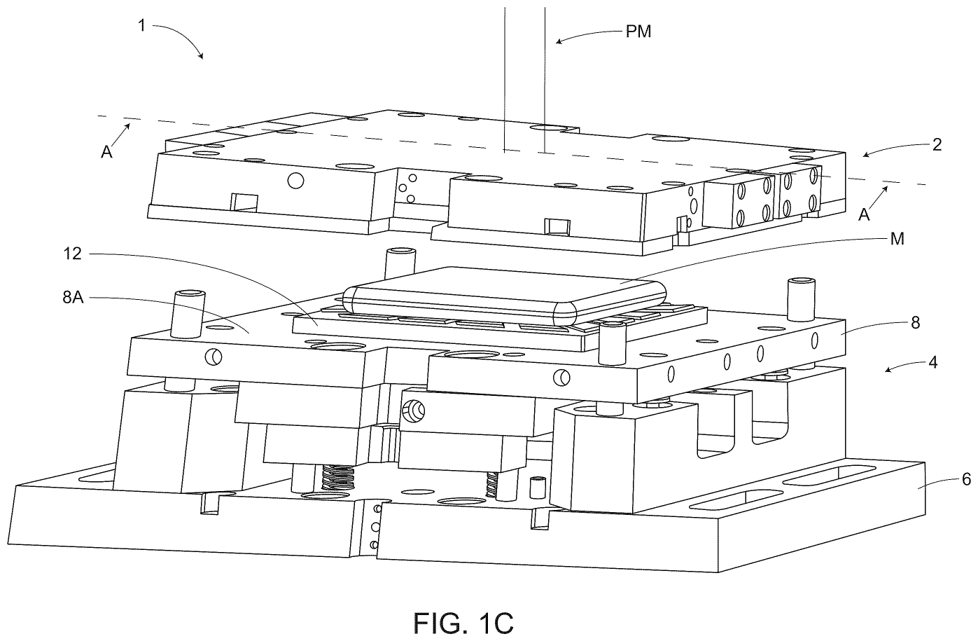

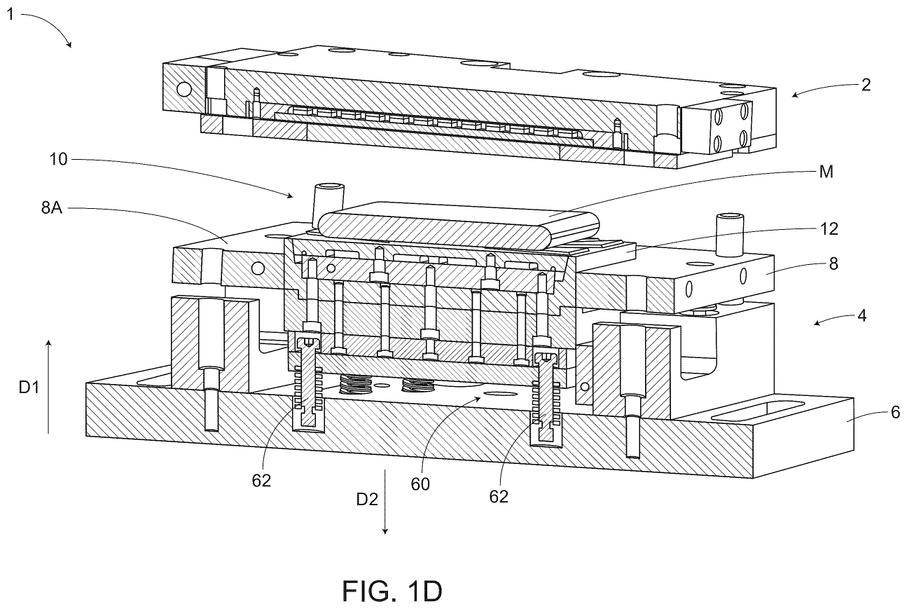

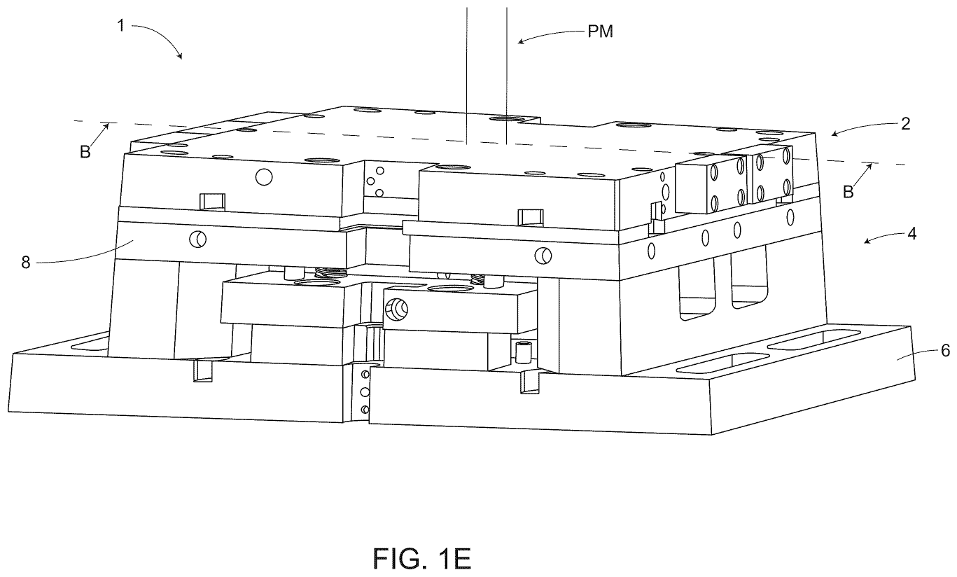

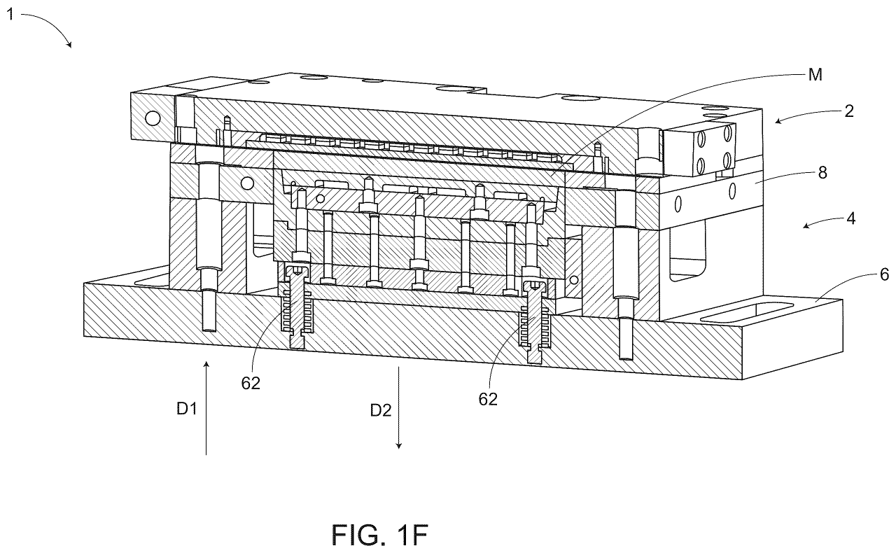

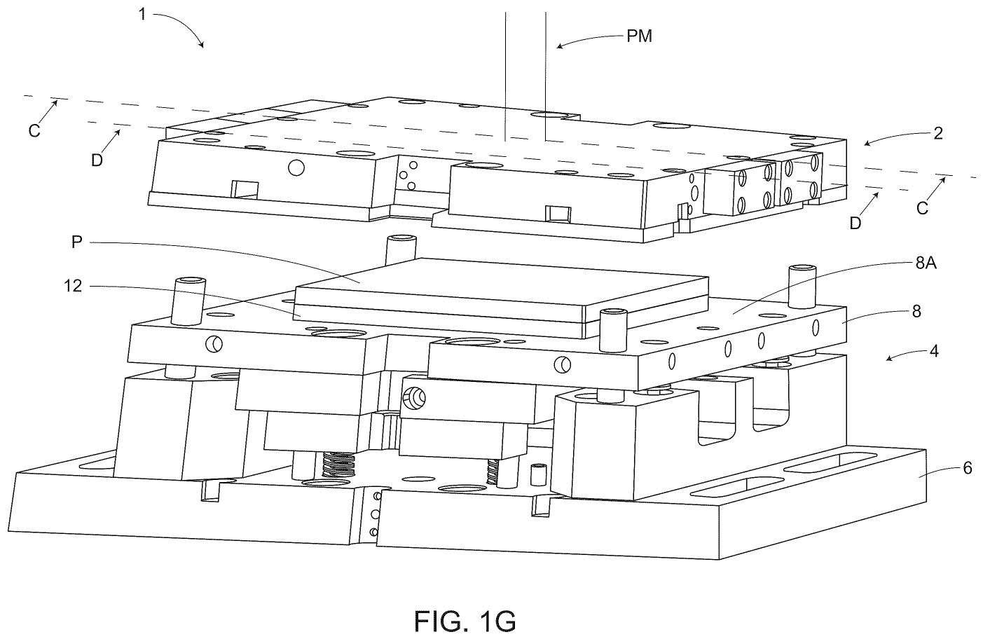

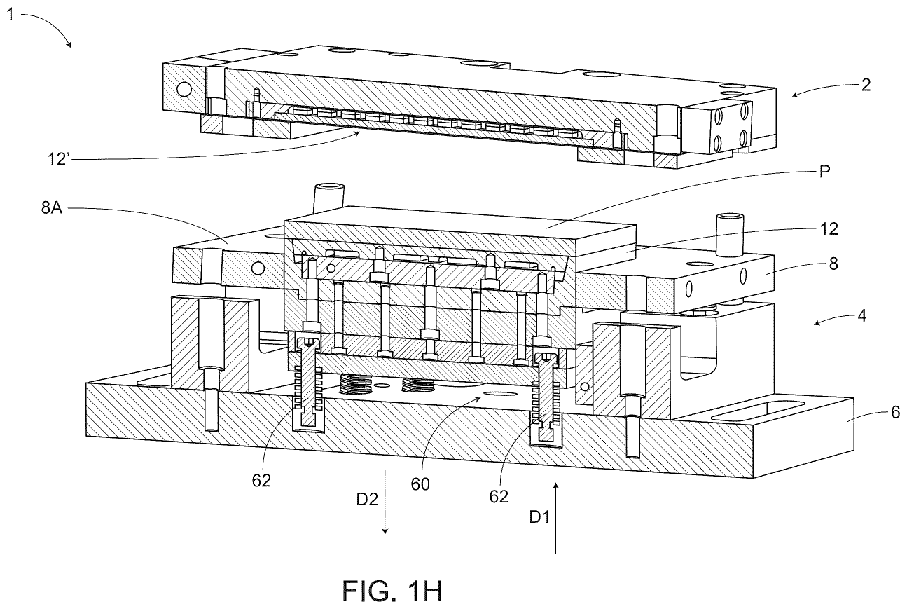

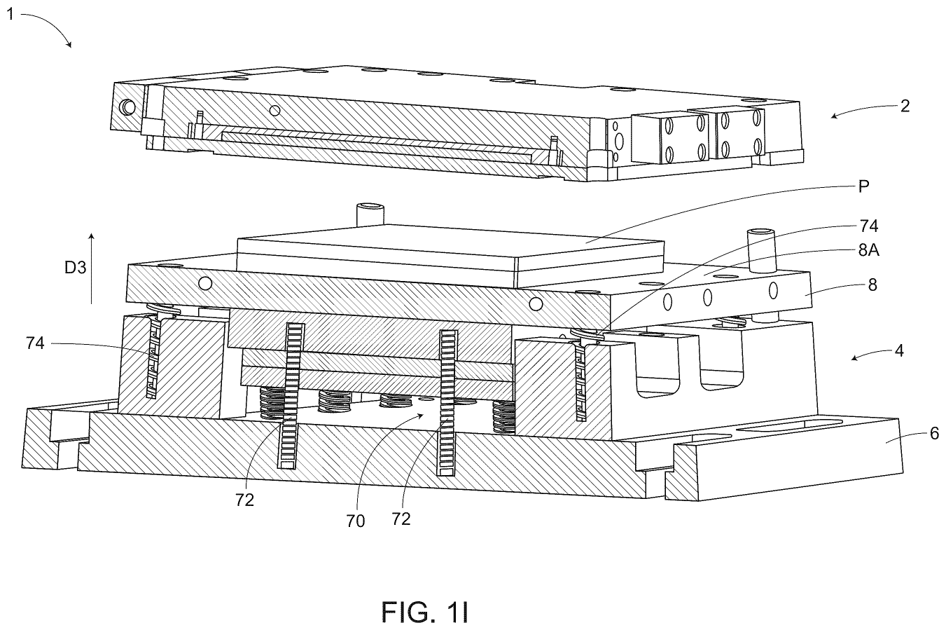

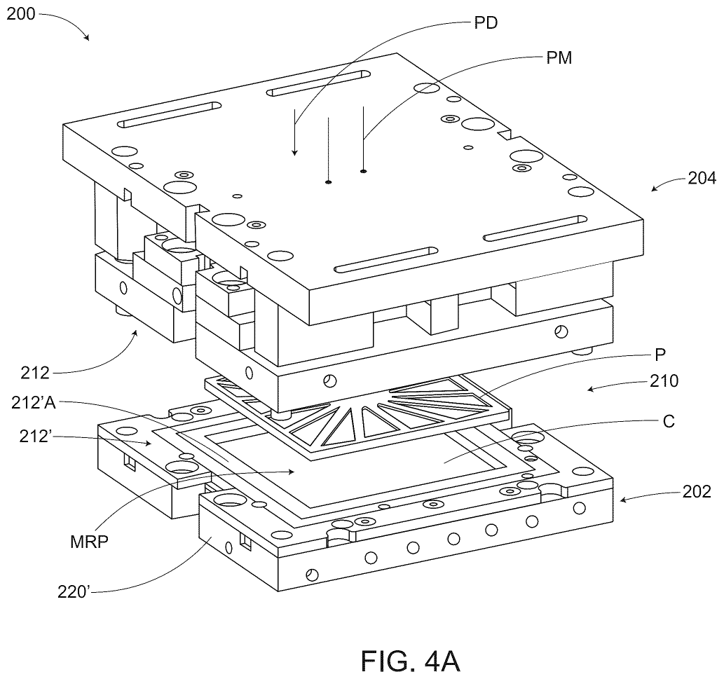

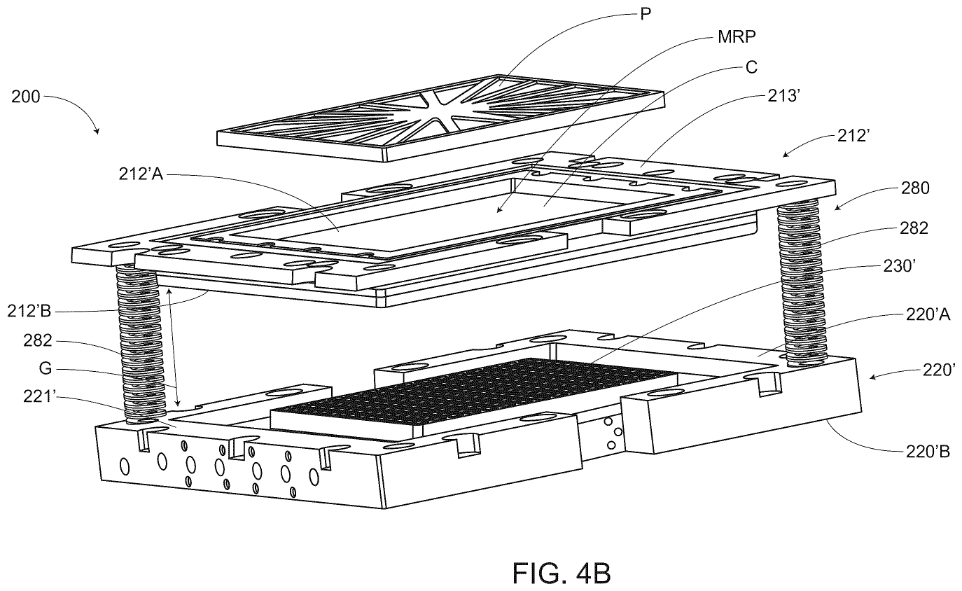

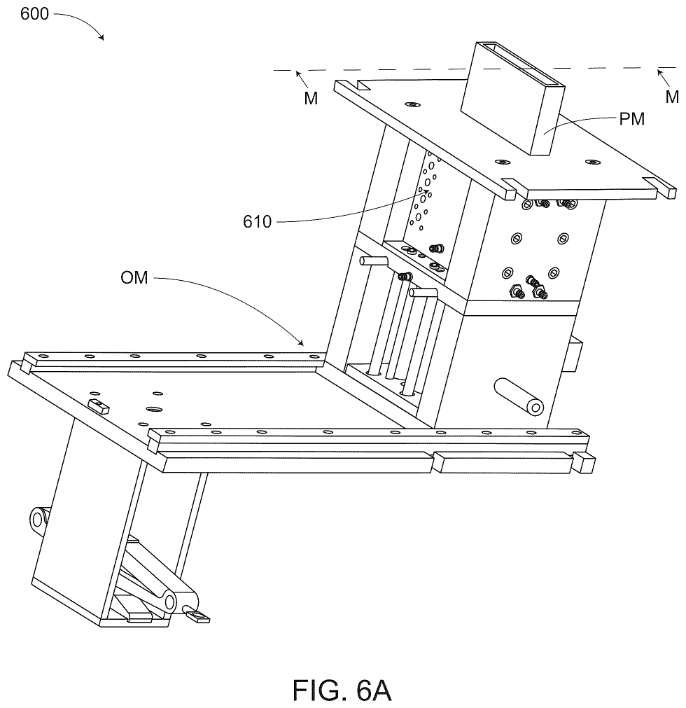

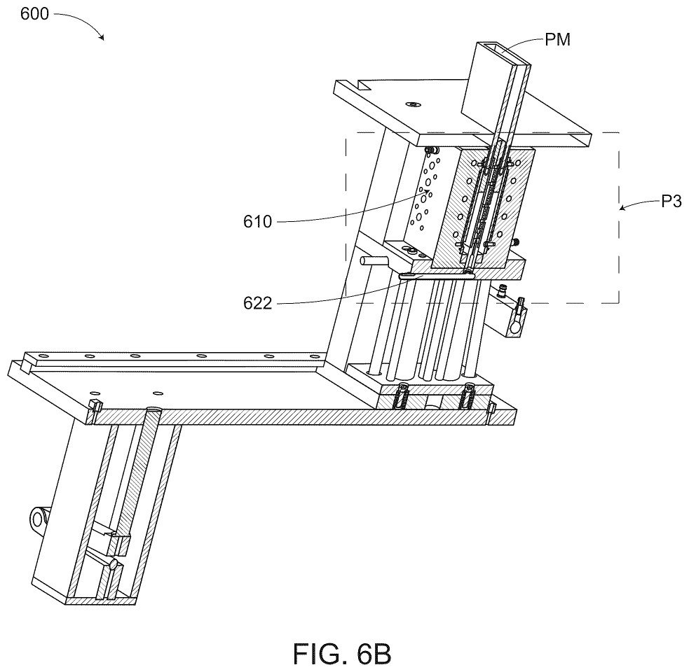

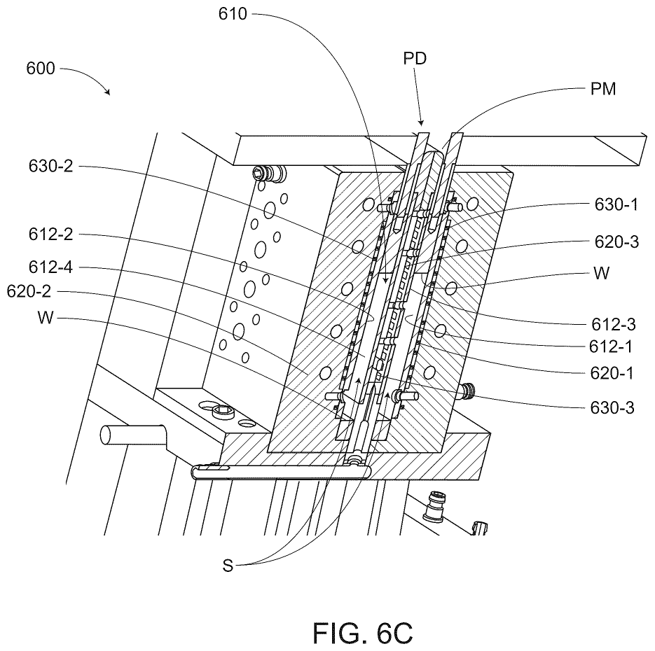

Reference is first made to FIGS. 1A to 1I illustrating a mold 1 according to an example of the presently disclosed subject matter. The mold 1 has an upper part 2 and a bottom part 4 and comprises a pressing mechanism 10 constituted by a first pressing layer 12 and a second pressing layer 12′. It is to be understood herein that the terms upper and bottom have been used herein in the context of the example illustrated in FIGS. 1A to 1I, and in other examples (for example, as the one illustrated in and described with respect to FIG. 4A), the mold can be used in the inverted manner, i.e., the part referred to as the upper part 2 in the example illustrated in FIGS. 1A to 1I can be at the bottom while the part referred to as the bottom part 4 in the example illustrated in FIGS. 1A to 1I can be at the top. The first pressing layer 12 is positioned at the bottom part 4 of the mold 1 and the second pressing layer 12′ is positioned at the upper part 2 of the mold 1. In the illustrated example, the upper part 2 is movable towards and away from the bottom part 4 for the operation of the mold 1. For instance, a press member PM is operatively coupled to the upper part 2 and thus to the second pressing layer 12′ to move the upper part 2, and thus the second pressing layer 12′, towards and away from the bottom part 4 and thus the first pressing layer 12, thereby operating the pressing mechanism 10. The press member PM can be or constitute a part of a piston arrangement, spring mechanism, a hydraulic mechanism, a magnetic/electrolytic mechanism or any other mechanism generally known in the art to operate the pressing mechanism. In some examples, press member PM can be operatively coupled to the first pressing layer 12 or to both the pressing layers 12 and 12′ to operate the pressing mechanism 10. In some examples (for example, as the one illustrated in and described with respect to FIGS. 6A to 6C), the press member can be configured to press a mixture onto any one or both of the pressing layers, without being operatively coupled to any of the pressing layers. Accordingly, the term pressing layer or pressing plate is to be understood herein as a surface that presses the mixture or a layer onto which the mixture is pressed. Further, the pressing mechanism is to understood as comprising an arrangement of one or more pressing layers, allowing processing (including pressing) of the mixture therebetween.

The bottom part 4 and the upper part 2 of the mold 1 define therebetween a mixture receiving space S configured to receive therewithin a mixture M that is to be processed by the mold 1 into a final product P, i.e., an article of manufacture. The mixture M can be a mixture of particulate and fibrous raw materials, including liquid content, mostly water. The wetted mixture can have a viscosity greater than 5,000,000 Cp, and in some examples closer to 100,000,000 Cp. The mixture M is placed on the first pressing layer 12, which in the illustrated example constitutes a bottom pressing layer 12, as shown in FIGS. 1C and 1D. Subsequently, the press member PM moves the upper part 2 towards the bottom part 4 of the mold 1 and the first and second pressing layers 12 and 12′ press the mixture M therebetween and extract the liquid contained in the mixture M, as shown in FIGS. 1E and 1F. Once the processing is complete, the upper part 2 is moved away from the bottom part 4 thereby lifting the second pressing layer 12′ from the final product P.

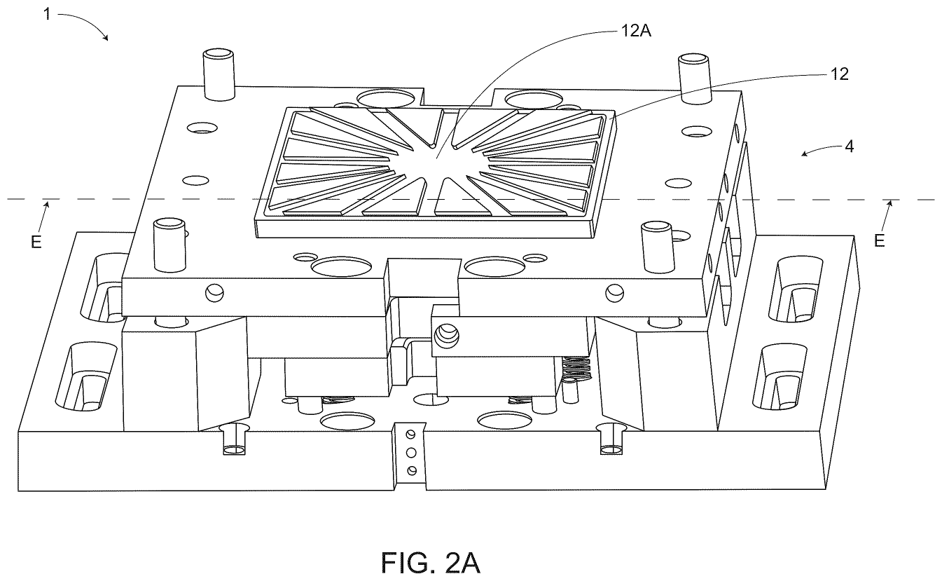

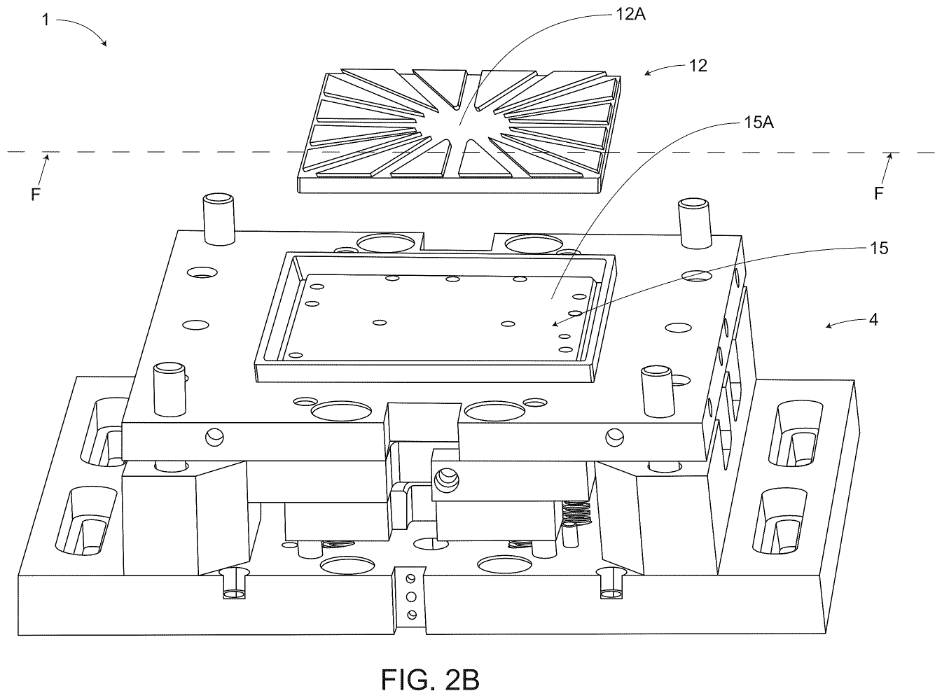

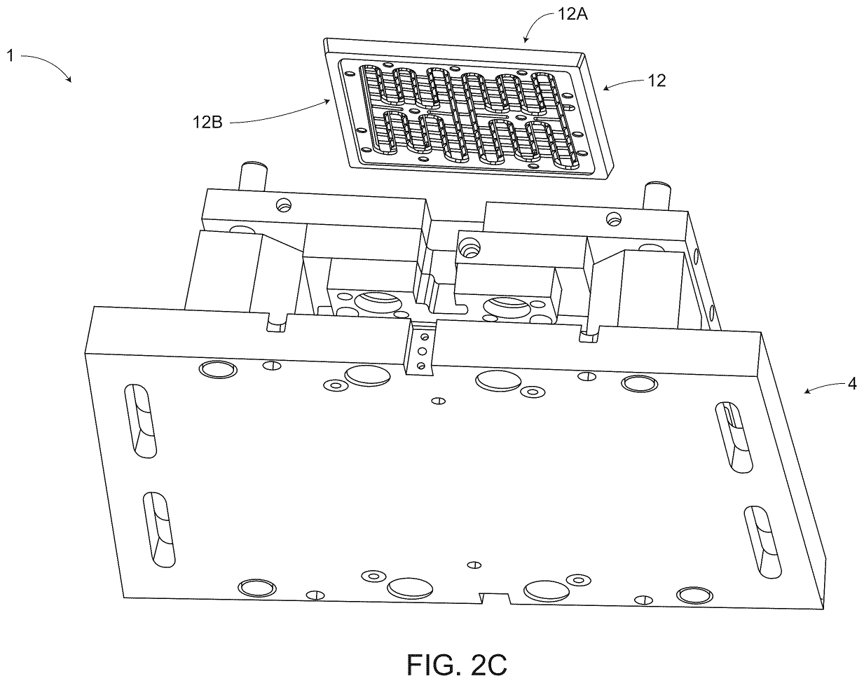

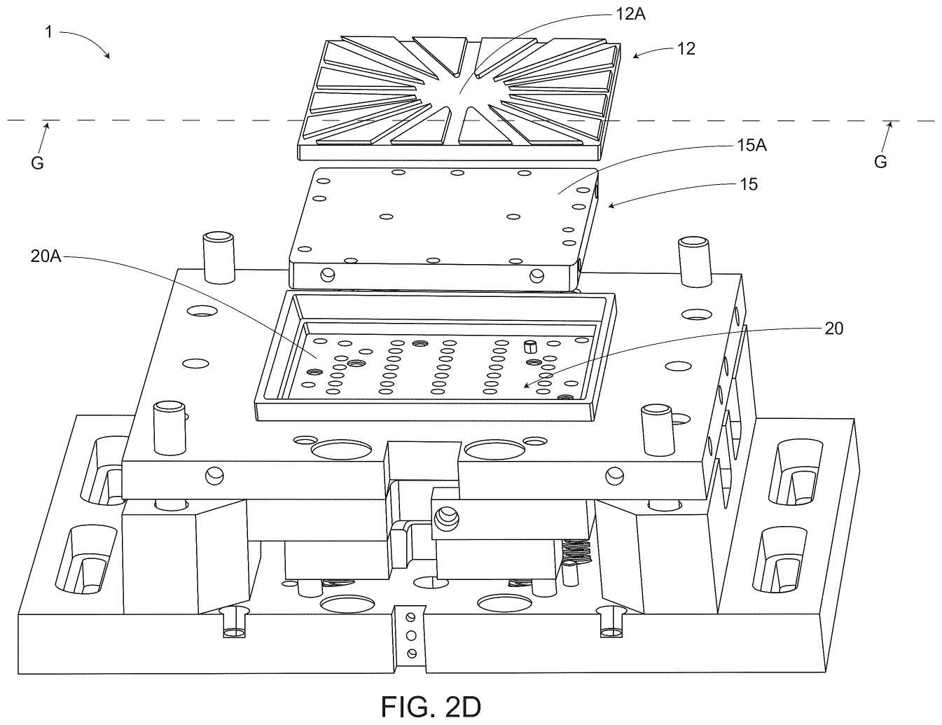

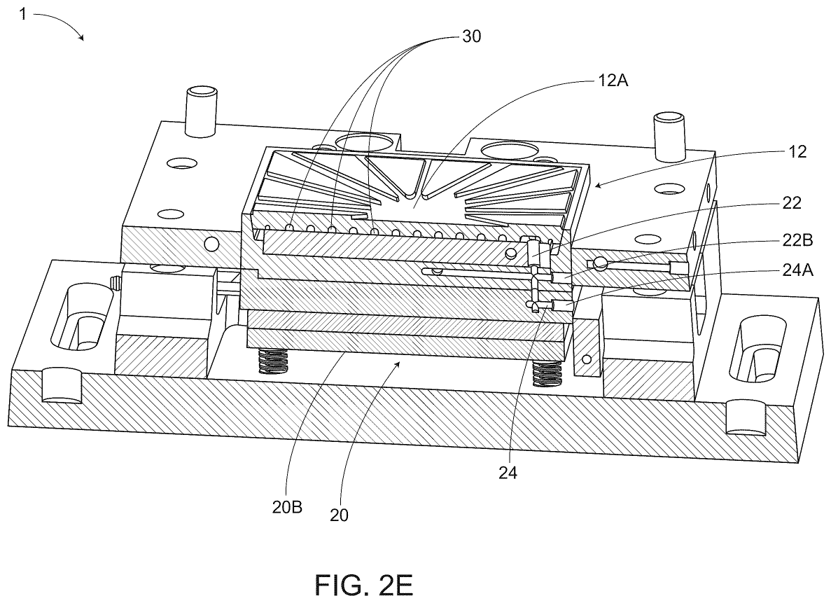

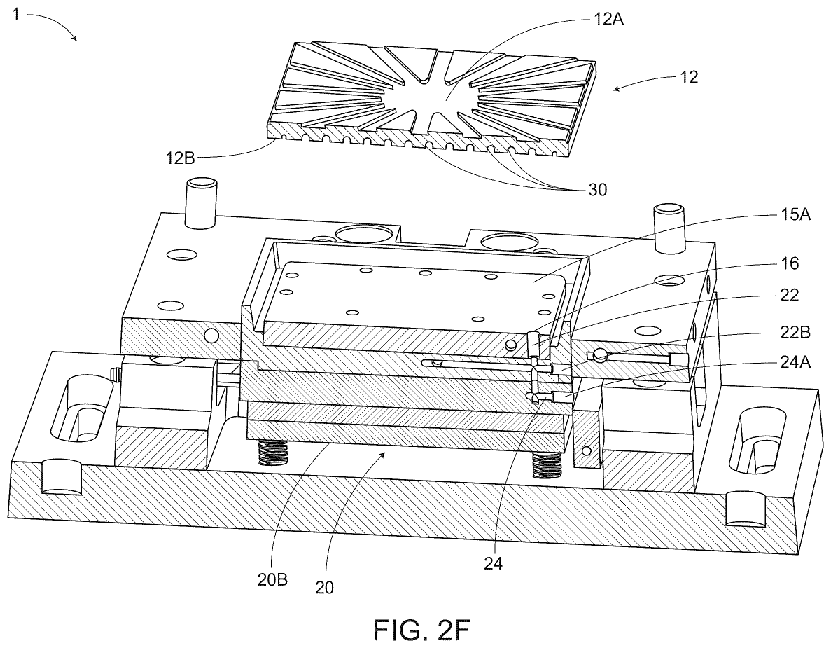

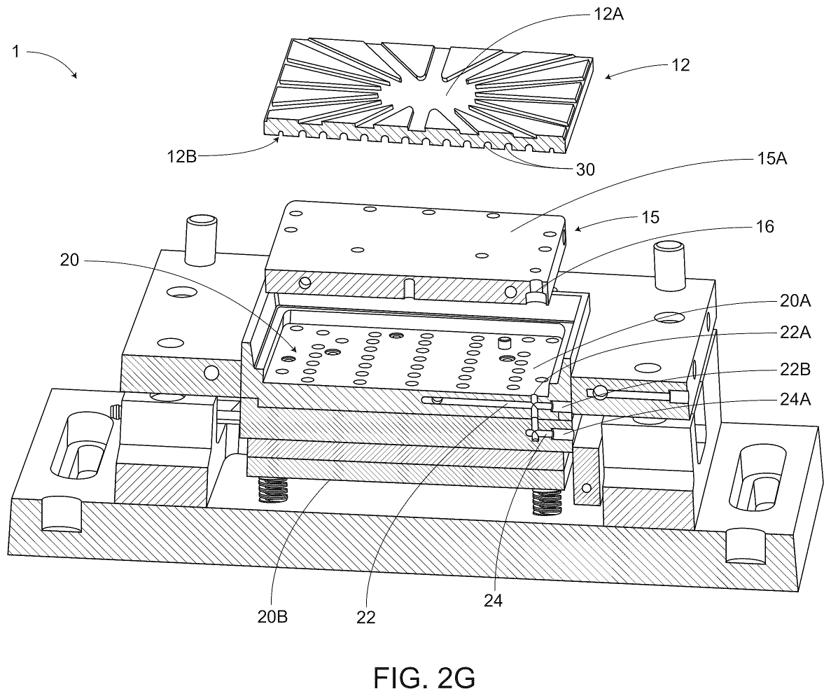

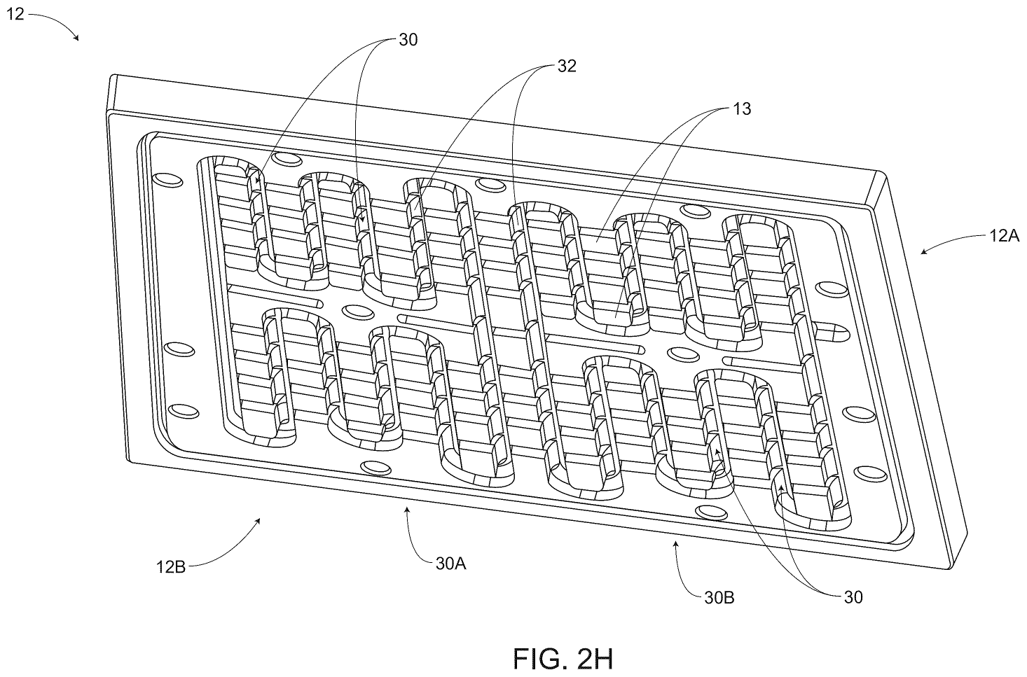

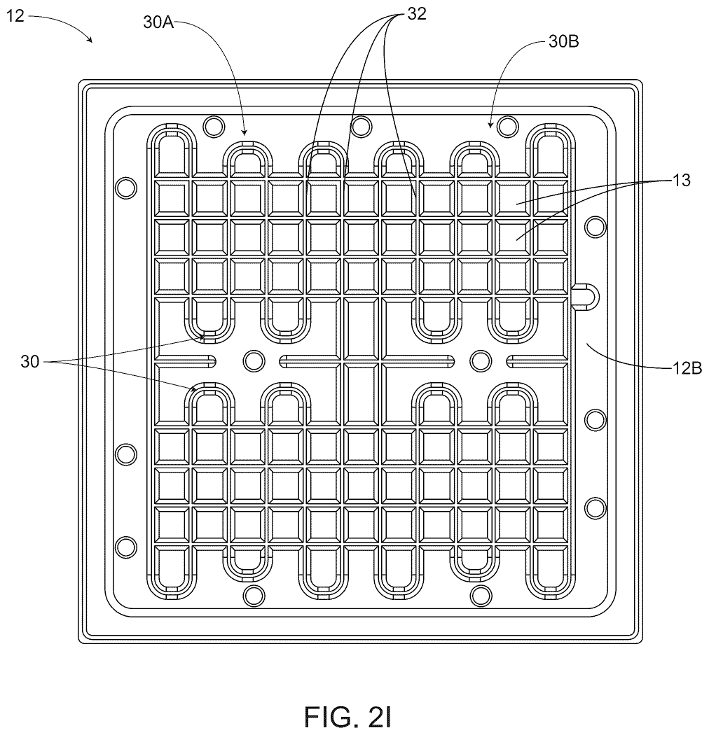

Reference is now made to FIGS. 2A to 2I illustrating the mold 1 to describe various features thereof. The upper part 2 of the mold 1 has not been shown for illustration purposes. The first pressing layer 12 has a pressing layer front surface 12A configured to press the mixture M and extract the liquid therefrom during the operation of the mold as described above, and an opposite pressing layer back surface 12B. The mold 1 further comprises a backing plate 20 having a backing plate front surface 20A facing the pressing layer back surface 12B and an opposite backing plate back surface 20B. The mold 1 further comprises a liquid accumulating space 30 extending parallel to the first pressing layer 12 configured to receive and accumulate the liquid extracted from the mixture M therewithin. The liquid accumulating space 30 is positioned between the pressing layer front surface 12A, i.e., the surface that will press the mixture and extract the liquid therefrom, and the backing plate back surface 20B. For the purposes of this description, it is to be understood herein that the term parallel when used in the context of the liquid accumulating space for the entirety of this description intends to mean that the liquid accumulating space is spread along a plane (specifically as horizontal plane, considering the direction of operation of the pressing mechanism 10 is along the vertical direction) extending along an area covered by the pressing layer. In other words, it is to be understood herein that the liquid accumulating space occupies an area along the plane parallel to the pressing layer which is substantially and significantly more than an area that would be occupied by a conduit, pipe, a network of pipes and conduits, or channels configured to drain out the liquid from the pressing layer. In yet other words, it is to be understood herein that the liquid accumulating space is configured to hold a volume of liquid significantly more than what a conduit, pipe, a network of pipes and conduits, or channels configured to drain out the liquid would be generally configured to hold.

In some examples, the liquid accumulating space can constitute a part of either or both the first pressing layer and the backing plate. In some examples, the liquid accumulating space can be completely within either of the first pressing layer or the backing plate. In some examples, the liquid accumulating space can be between the first pressing layer and the backing plate, whereas the backing plate and the first pressing layer are spaced from each other. In some examples, the mold can further comprise an intermediate plate between the first pressing layer and the backing plate, and the liquid accumulating space can constitute a part of the intermediate plate. It is to be understood herein that the position of the liquid accumulating space can be constituted according to either alone or any combination of the above-mentioned examples.

In some examples, the first pressing layer can be a solid pressing plate and the liquid can flow into the liquid accumulating space from a periphery of the pressing layer. In some examples, the first pressing layer can include a liquid permeable pressing plate that allows the liquid extracted from the mixture to flow directly therethrough into the liquid accumulating space. In some other examples, the first pressing layer can include a capillary fabric configured to contact the mixture and absorb the liquid therefrom, which can then flow into the liquid accumulating space. In the examples of the mold including the capillary fabric, the capillary fabric can be positioned either directly on the backing plate or on an intermediate plate that can be either a solid plate or a liquid permeable plate.

In some or all of the examples relating to the liquid accumulating space described above, the liquid accumulating space extends under at least a majority of area covered by the pressing layer front surface, or at least 30%, at least 40%, at least 60%, at least 70%, at least 80%, at least 90% of area covered by the pressing layer front surface. In some or all of the examples relating to the liquid accumulating space described above, the liquid accumulating space extends over at least a majority of area covered by the backing plate back surface, or at least 30%, at least 40%, at least 60%, at least 70%, at least 80%, at least 90% of area covered by the backing plate back surface.

In some examples, the first pressing layer is a liquid permeable pressing layer, i.e., either the first pressing layer is a liquid permeable pressing plate or includes a capillary fabric positioned over a liquid permeable intermediate plate, the liquid permeable pressing layer comprises a plurality of pores that allow the liquid to flow therethrough into the liquid accumulating space. In such examples, a combined cross-sectional area of the pores at a cross-section taken parallel to the pressing layer front surface is smaller than a cross-sectional area of the liquid accumulating space at a cross-section taken parallel to the pressing layer front surface. In other words, if there are X number of pores on the pressing layer front surface and each pore occupy an area Y, then the total area X*Y is lesser than the area occupied by the liquid accumulating space in a plane parallel to the pressing layer front surface. In examples where the liquid permeability is achieved by an interconnected network of pores through the respective plate, the total area occupied by the pores at a virtual plane parallel to the pressing layer front surface is lesser than the area occupied by the liquid accumulating space in a virtual plane passing through the liquid accumulating space and parallel to the pressing layer front surface.

In general, the liquid accumulating space can be constituted by a random space between the pressing plate front surface and the backing plate back surface. The space can be within the pressing layer and/or the backing plate, or between the backing plate front surface and the pressing layer back surface with these surfaces being spaced apart from each other by spacer elements. In some examples, the pressing layer and the backing plate contact each other at least a periphery thereof and seal the liquid accumulating space at that periphery to prevent the liquid from spilling over within the mold. Alternatively, or additionally, the liquid accumulating space can be constituted in a more arranged manner by liquid accumulating channels formed on either or both of the first pressing layer and the backing plate. The liquid accumulating channels can be formed on pressing layer back surface, backing plate front surface, or at least partially within the pressing layer and/or backing plate. In some examples, especially when the mold comprises an intermediate plate between the backing plate and the first pressing layer, the liquid accommodating space can be constituted by liquid accumulating channels formed on the intermediate plate on any or both of its intermediate plate front surface facing the pressing layer or on intermediate layer back surface facing the backing plate. It is to be understood herein that the liquid accumulating space can be constituted according to either alone or in any combination of the above-mentioned examples. For instance, in some examples, the liquid accumulating channels can be formed on all of the pressing layer back surface, the intermediate layer front and back surfaces, and the backing plate front surface.

In some examples, the liquid accumulating space can be large enough to accumulate the liquid extracted during production of a number of articles, and then can be emptied during maintenance of the mold or by drying off of the liquid naturally. In some examples, the mold can include one or more drainage channels in fluid communication with the liquid accumulating space for draining out the liquid from the liquid accumulating space and/or the mold. The liquid accumulating space can be divided into more than one regions, each region being in fluid communication with at least one of the drainage channels. The regions can or can not be in fluid communication with each other. For instance, the regions can be divided according to the volume of liquid to be received at a particular location along the liquid accumulating space and the number of drainage channels to which a particular region needs to be in fluid communication with is decided accordingly during manufacturing of the mold.

In general, the liquid can be drained out of the liquid accumulating space using a suction unit, which can or can not constitute a part of the mold. The suction unit can be used to suck the liquid out of the liquid accumulating space via the drainage channels and/or via a separate network of suction channels/conduits. In the examples where the suction unit is fluidly connected to the liquid accumulating space via a separate network of suction conduits/channels, the suction unit can be operated as a pump to pump a washing liquid into the mold for washing the mold, or to assist in ejecting the final product from the mold.

Although the arrangement of the pressing layer, the backing plate, the intermediate layer (if any), the spacer elements (if any), and the liquid accumulating space can be obtained according to any of the above-described examples either alone or in any combination, only a few examples have been illustrated herein for the purpose of conciseness of the presently disclosed subject matter, and all other examples and modifications thereof are to be considered as falling within the scope of the presently disclosed subject matter.

For instance, in the example illustrated in FIGS. 2A to 2I, the first pressing layer 12 is a liquid permeable pressing plate 12 configured to allow the liquid extracted from the mixture to permeate therethrough into the liquid accumulating space 30. The liquid accumulating space 30 is constituted by liquid accumulating channels 32 formed on the pressing layer back surface 12B. As can be best seen in FIG. 2H, the liquid accumulating channels 32 are formed as trenches on the pressing plate back surface 12B and the spacing portions 13 of the pressing plate back surface 12B rest on the intermediate plate 15 thereby constituting spacer elements for defining the liquid accumulating space 30 between the intermediate plate 15 and the pressing layer front surface 12A. The intermediate plate 15 rests on the backing plate front surface 20A. In the examples without the intermediate plate, the liquid permeable pressing plate 12 can rest directly on the backing plate front surface 20A. In other examples, the intermediate plate 15 can be integrally formed with the backing plate 20 thereby forming a part of the backing plate 20 with its front surface, i.e., intermediate plate front surface 15A constituting the backing plate font surface.

The mold 1 further comprises drainage channels 22, one of which is visible in the cross-sectional views of the mold 1 illustrated in FIGS. 2E, 2F, and 2G. The drainage channel 22 has a drainage inlet port 22A formed in the backing plate front surface 20A. The intermediate plate comprises drainage openings 16, which are through-holes formed through the intermediate layer 15. The drainage opening 16 is aligned with and is in fluid communication with the drainage inlet port 22A when assembled. Thus, the liquid accumulating space 30 is in fluid communication with the drainage channel 22 via the drainage opening 16 and the drainage inlet port 22A. In the examples without the intermediate layer, the liquid accumulating space can be directly in fluid communication with the drainage inlet ports. The drainage channel 22 is formed within the backing plate 20 and comprises a drainage outlet port 22B in a side surface thereof to discharge the liquid therefrom. The mold 1 further comprises suction channels 24, only one visible in the cross-sectional views of the mold 1 illustrated in FIGS. 2E, 2F, and 2G. In the illustrated example, the suction channel 24 is in fluid communication with the liquid accumulating space 30 via the drainage channel 22. In other examples, the suction channel 24 can be separate, i.e., fluidly isolated, from the drainage channel 22. The suction channel comprises a suction port 24A in the side surface of the backing plate that can be connected to a suction unit, that can or can not constitute a part of the mold, to suck the liquid out of the liquid accumulating space more efficiently than the liquid flowing naturally out of the drainage channels 22.

As can be best seen in FIGS. 2H and 2I, the liquid accumulating space 30 is divided into two regions 30A and 30B, which in the illustrated example are fluidly connected to each other. Thus, both the regions 30A and 30B are in fluid communication with the drainage channels 22. In some examples, the two regions can be fluidly disconnected to each other and can be fluidly connected to different ones of the drainage channels 22. It is to be understood herein that the pattern of the liquid accumulating channels need not necessarily be same as the one illustrated and can be any other pattern suitable to increase the area covered by the channels to increase the volume capacity of the liquid accumulating space.

In the examples with the capillary fabric, the capillary fabric can be positioned on the liquid permeable pressing plate 12, or on the pressing plate 12 not being liquid permeable, or on the intermediate plate 15 (either liquid permeable or not) without the pressing plate 12 (in this case, the capillary fabric constituting the pressing layer), or directly on the backing plate front surface 20A with the liquid accumulating channels formed on or within the backing plate (in this case as well, the capillary fabric constituting the pressing layer).

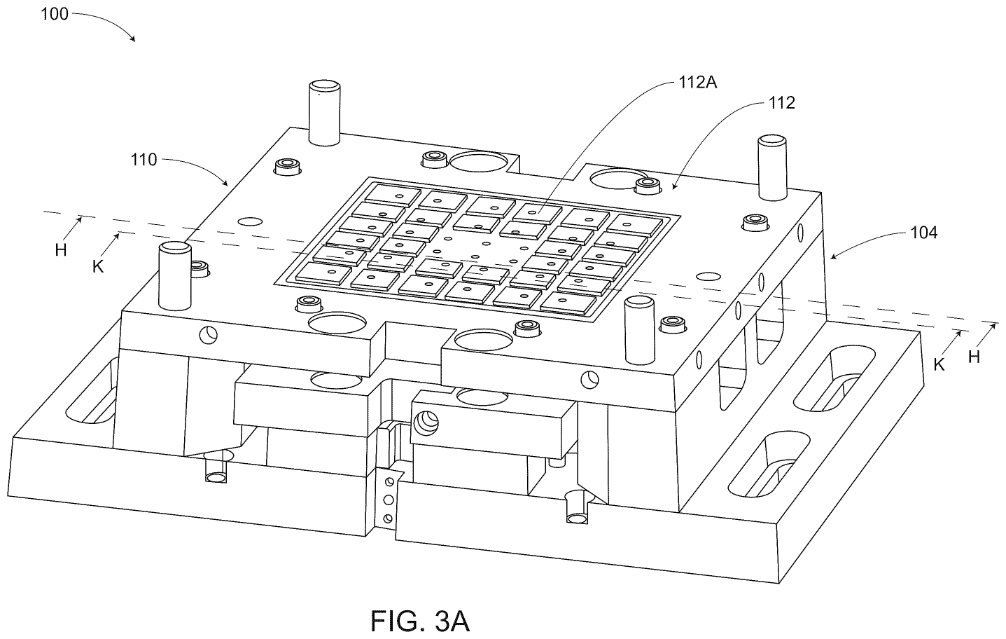

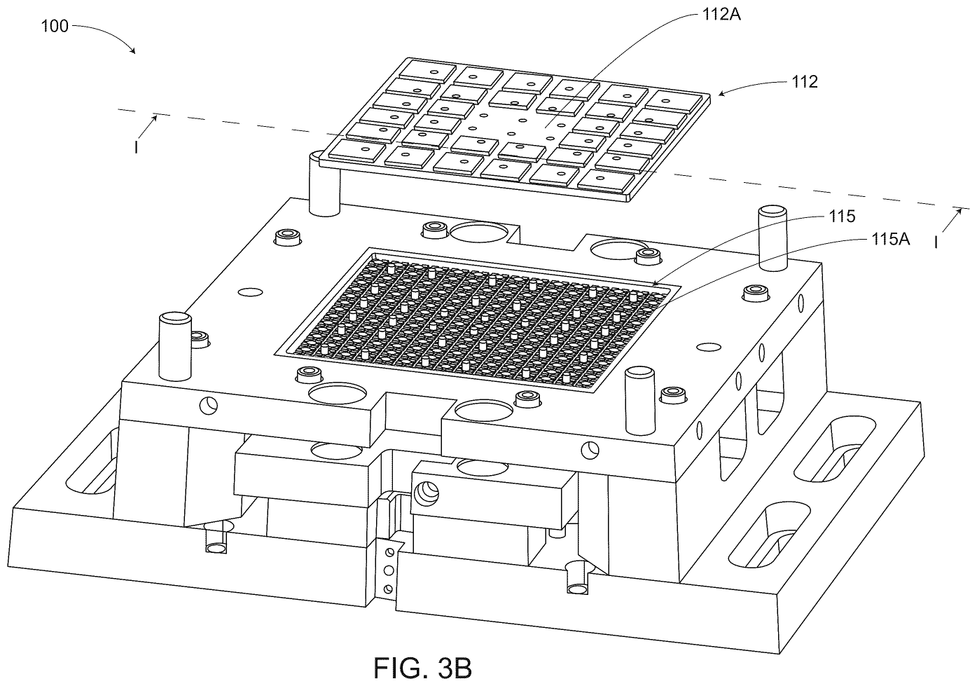

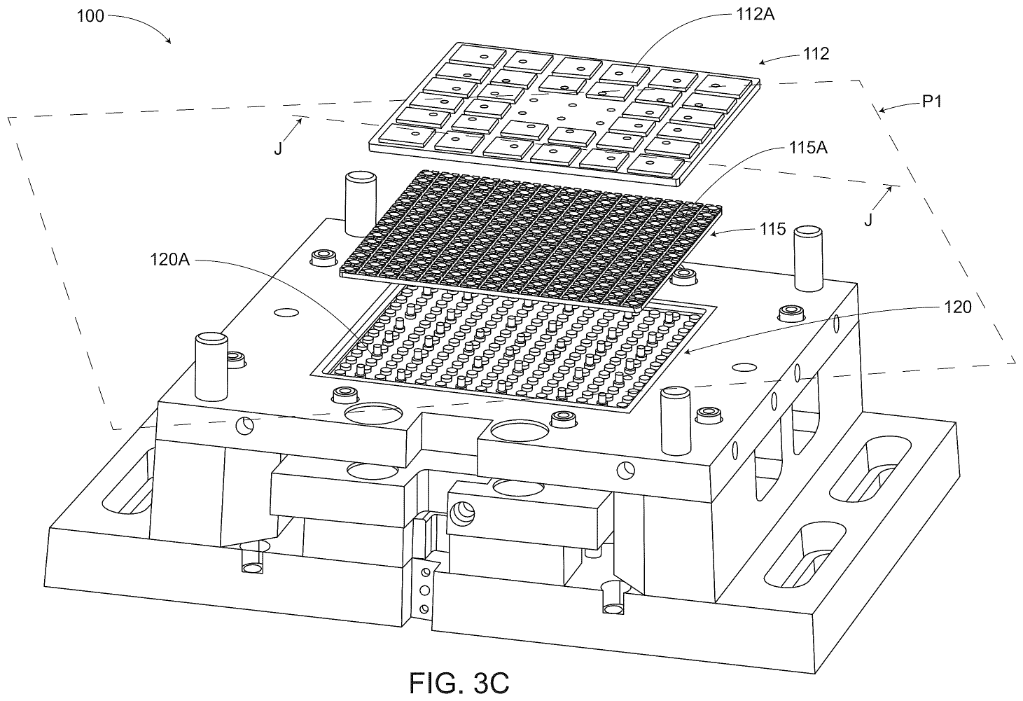

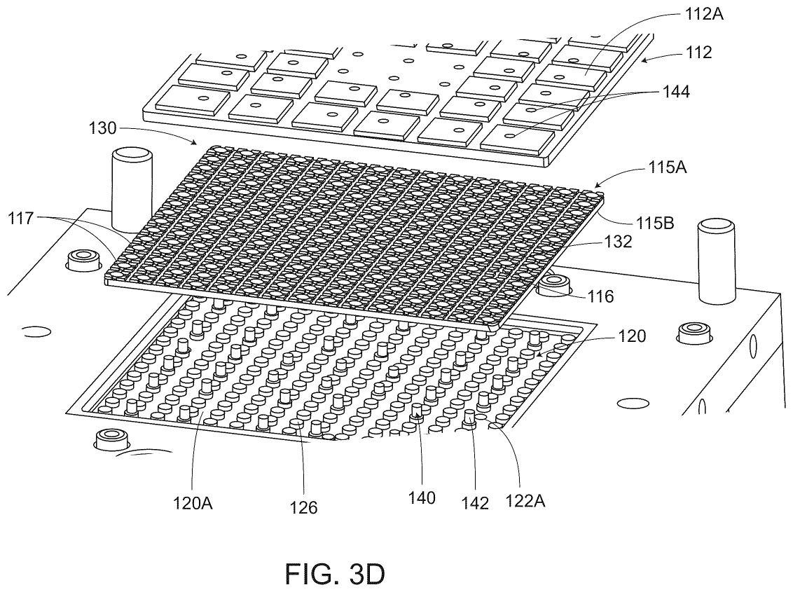

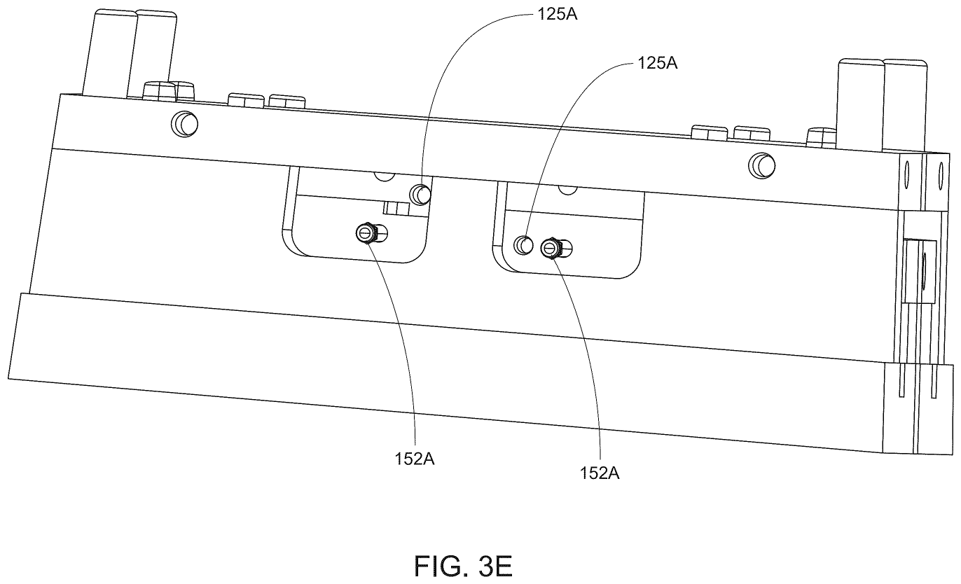

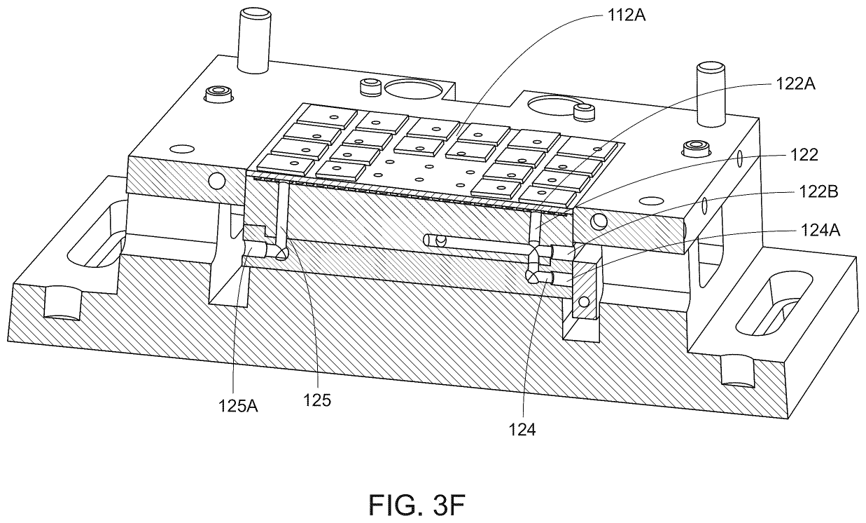

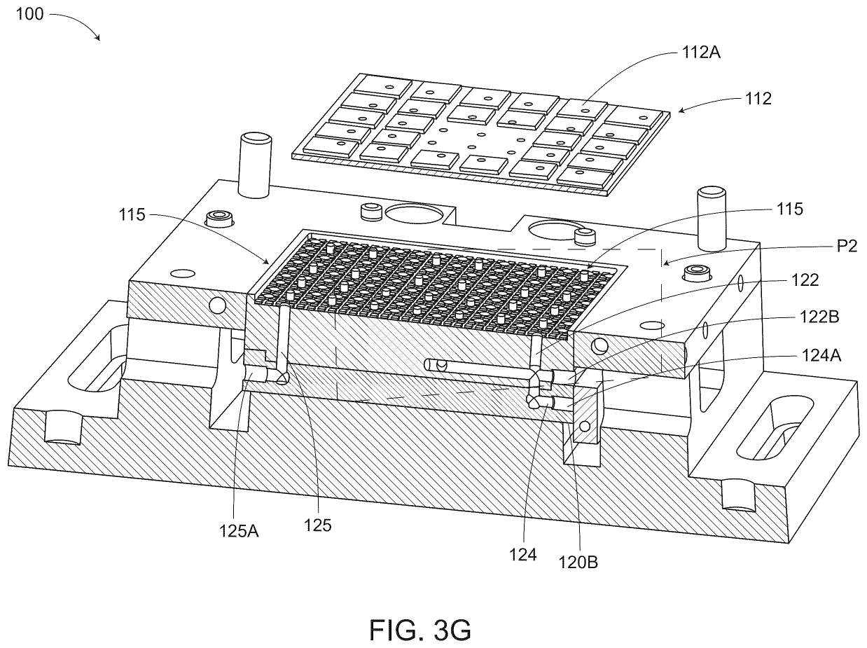

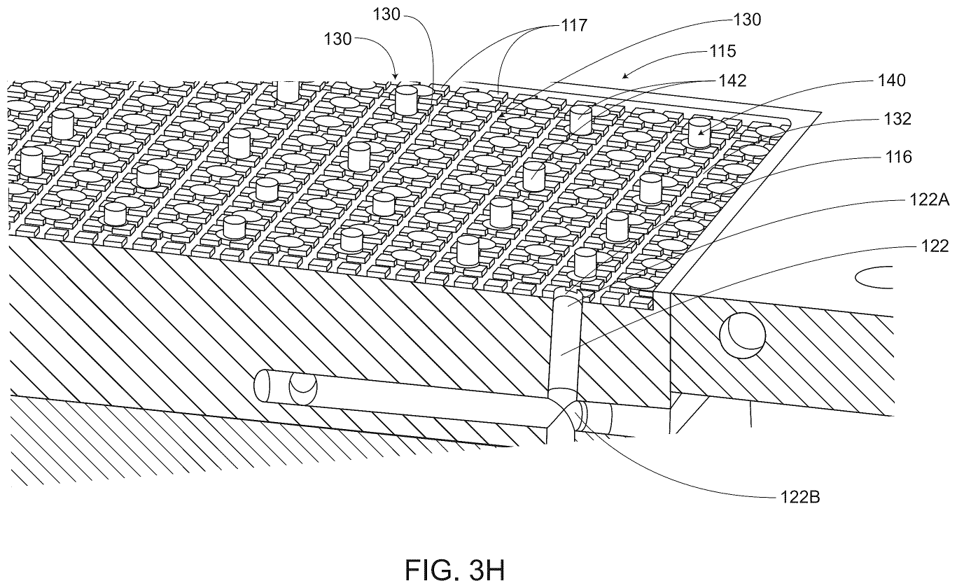

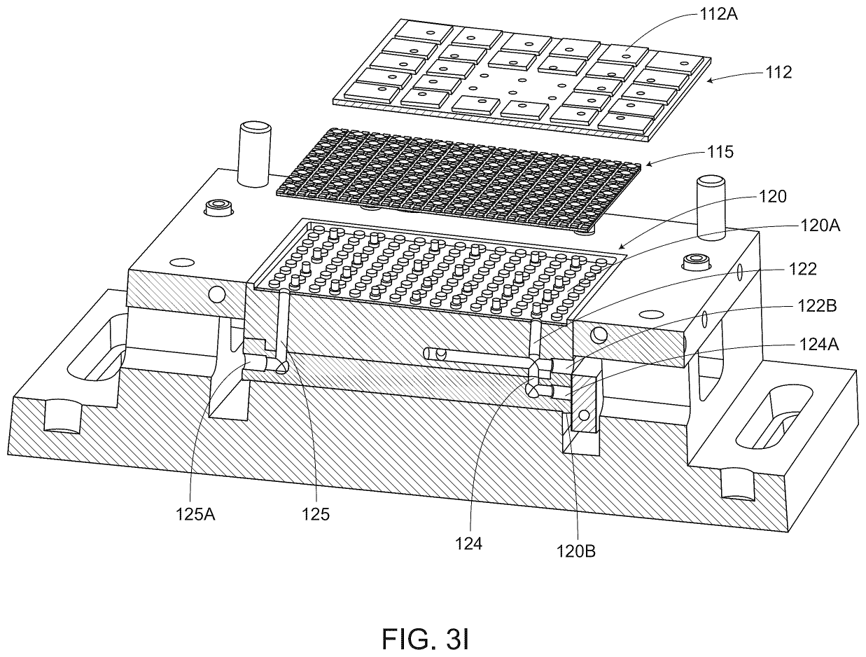

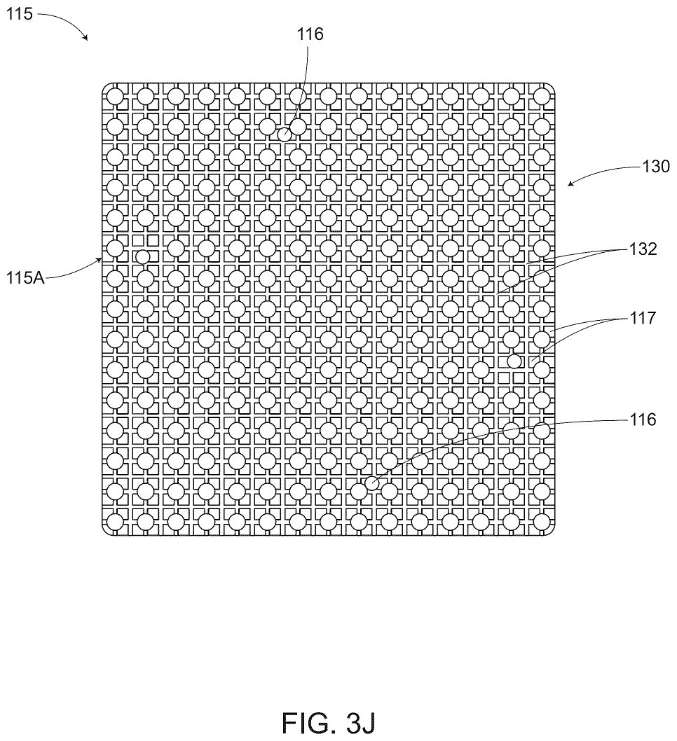

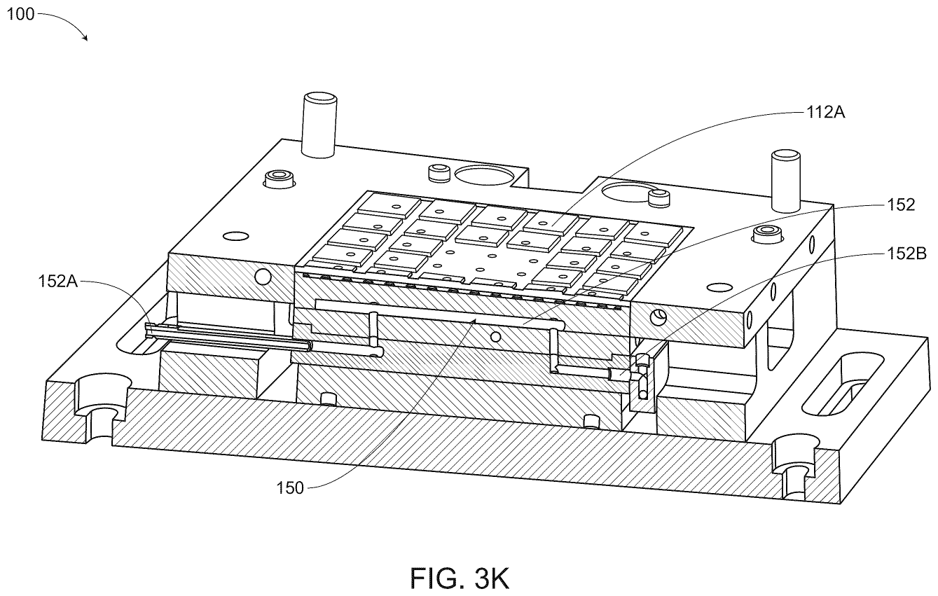

Reference is now made to FIGS. 3A to 3K illustrating a mold 100 according to an example of the presently disclosed subject matter. The mold 100 has some or all of the features corresponding to those of the mold 1, and is configured to operate in the same manner as mold 1 to process the mixture (for instance, mixture M) to produce article of manufacture (for instance, final product P). The mold 100 has been shown in a state during processing of the mixture therewithin, i.e., when the two parts of the mold are pressed on to each other, and it is to be understood herein that the upper part of the mold as well as the mixture have not been shown for illustration purposes.

It is to be understood herein that the mold 100 as described below has all the features related to operation of the mold same as those of the mold 1 as described throughout the present description. For instance, some or all of the features relating to upper and bottom part of the mold, the pressing mechanism, the press member, the pressing layers, the backing plate, the intermediate plate, the liquid accumulating space, the drainage channels, the suction unit and suction channels, and the processing of the mixture to produce the final product as described with respect to the mold 1 can constitute the features of the mold 100 according to various examples of the presently disclosed subject matter. Thus, all the examples described above with respect to these features of mold 1 apply mutatis mutandis to those features if and when they constitute the features of mold 100 as well, and their repetition has been avoided for the purposes of preciseness and clarity. The main difference between the mold 1 and mold 100 being the realization of the liquid accumulating space. For instance, in the mold 100, the liquid accumulating space has been illustrated as being constituted by liquid accumulating channels formed on the intermediate plate rather than the pressing layer as in mold 1 described above. Apart from this, some or all the features of mold 1 can constitute the features of mold 100 as well according to various examples. In fact, in some examples, the liquid accumulating channels can be formed on the pressing layer of mold 100 as well (in a similar manner as described for mold 1 above) in addition to the liquid accumulating channels formed on the intermediate plate of mold 100 as described herein below. Moreover, some or all of the additional features of the mold 100, such as heating mechanism, fixing mechanism, and spacer elements can be incorporated into the mold 1 in a similar manner as described below for mold 100. The corresponding reference numerals have been used for describing the components of mold 100 as those of mold 1 for ease of understanding of other examples that are although not shown but are described generally and are within the scope of the presently disclosed subject matter.

The mold 100 comprises a first pressing layer 112 constituting a part of a pressing mechanism 110 and positioned at bottom part 104 of the mold 100. The first pressing layer 112 corresponds to the first pressing layer 12 of the mold 1 and can include some or all the features thereof, and thus, all the examples and variations described above with respect thereto apply mutatis mutandis to the pressing layer 112. For instance, the pressing layer 112 can include a capillary fabric positioned directly on the backing plate or on an intermediate plate that can or can not be liquid permeable, or can include a pressing plate that can or can not be liquid permeable.

The first pressing layer 112 has a pressing layer front surface 112A configured to press the mixture M and extract the liquid therefrom, and an opposite pressing layer back surface 112B. The mold 100 further comprises a backing plate 120 having a backing plate front surface 120A facing the pressing layer back surface 112B and an opposite backing plate back surface 120B. The mold 100 further comprises a liquid accumulating space 130 extending parallel to the first pressing layer 112 configured to receive and accumulate the liquid extracted from the mixture M therewithin. The liquid accumulating space 130 is positioned between the pressing layer front surface 112A, i.e., the surface that will press the mixture and extract the liquid therefrom, and the backing plate back surface 120B.

It is to be understood herein that the liquid accumulating space 130 corresponds to the liquid accumulating space 30 and all the definitions and/or examples described above with respect to the accumulating space 30 apply to the liquid accumulating space 130 and their repetition has been avoided for the purposes of preciseness and clarity of the present description.

It is to be understood herein that the example of the mold illustrated in FIGS. 3A to 3K show the features of the mold according to one specific realization of the components and the features can be realized according to the examples of the mold generally described above either alone in any combination. For instance, in the example illustrated in FIGS. 3A to 3K, the first pressing layer 112 is a liquid permeable pressing plate 112 configured to allow the liquid extracted from the mixture to permeate therethrough into the liquid accumulating space 130. The mold 100 further comprises the intermediate plate 115, on which the liquid permeable pressing plate 112 rests, when assembled. The intermediate plate 115 has an intermediate plate front surface 115A facing the liquid permeable pressing plate 112 and an opposite intermediate plate back surface 115B facing the backing plate 120. The liquid accumulating space 130 is constituted by liquid accumulating channels 132 formed on the intermediate layer front surface 115A. As can be best seen in FIG. 3H, the liquid accumulating channels 132 are formed as trenches on the intermediate layer front surface 115A and the pressing layer back surface 112B rests on the spacing portions 117 of the intermediate layer front surface 115A thereby defining the liquid accumulating space 130 between the intermediate plate 115 and the pressing layer back surface 112B. The intermediate plate 115 rests on the backing plate front surface 120A. In the examples without the intermediate plate, the liquid accumulating channels can be formed on the backing plate front surface 120A and the liquid permeable pressing plate 112 can rest directly on the backing plate 120. In other examples, the intermediate plate 115 can be integrally formed with the backing plate 120 thereby forming a part of the backing plate 120 with its front surface, i.e., intermediate plate front surface 115A constituting the backing plate font surface.

The mold 100 further comprises drainage channels 122, one of which is visible in the cross-sectional views of the mold 100 illustrated in FIGS. 3F, 3G, 3H, and 3I. The drainage channel 122 has a drainage inlet port 122A formed in the backing plate front surface 120A. The intermediate plate 115 comprises drainage openings 116, which are through-holes formed through the intermediate layer 115. The liquid accumulating channels 132 define path for the liquid to the drainage openings 116. The drainage opening 116 is aligned with and is in fluid communication with the drainage inlet port 122A when assembled. Thus, the liquid accumulating space 130 is in fluid communication with the drainage channel 122 via the drainage opening 116 and the drainage inlet port 122A. In the examples without the intermediate layer, the liquid accumulating space can be directly in fluid communication with the drainage inlet ports. The drainage channel 122 is formed within the backing plate 120 and comprises a drainage outlet port 122B in a side surface thereof to discharge the liquid therefrom. The mold 100 further comprises suction channels 124 and 125. It is to be understood herein that although two suction channels 124 and 125 are visible in the views of the mold 100 shown herein, there can be more suction channels positioned separately of or within the backing plate 120. In the illustrated example, the suction channel 124 is in fluid communication with the liquid accumulating space 130 via the drainage channel 122. The suction channel 125 is a separate channel and is fluidly isolated from the drainage channel 122. The suction channels 124 and 125 comprise respective suction ports 124A and 125A in the side surfaces of the backing plate 120 that can be connected to a suction unit, that can or cannot constitute a part of the mold, to suck the liquid out of the liquid accumulating space more efficiently than the liquid flowing naturally out of the drainage channels 122.

Although in the illustrated example, the liquid accumulating space 130 is a single continuous space and is not divided into regions and while of the liquid accumulating space 130 is in fluid communication with all the drainage channels 122, it is to be understood herein that in some examples, the liquid accumulating space 130 can be divided into more than one regions, which can or cannot be fluidly connected to each other. In such examples, the regions can be fluidly connected to one or more of the drainage channels 122. It is to be understood herein that the pattern of the liquid accumulating channels need not necessarily be same as the one illustrated herein and can be any other pattern suitable to increase the area covered by the channels to increase the volume capacity of the liquid accumulating space.

In the examples with the capillary fabric, the capillary fabric can be positioned on the liquid permeable pressing plate 112, or on the pressing plate 112 not being liquid permeable, or on the intermediate plate 115 (either liquid permeable or not) without the pressing plate 112 (in this case, the capillary fabric constituting the pressing layer), or directly on the backing plate front surface 120A with the liquid accumulating channels formed on or within the backing plate (in this case as well, the capillary fabric constituting the pressing layer).

The mold 100 further comprises spacer elements 126 positioned at least partially within the liquid accumulating space 130. The spacer elements 126 are integrally formed with and protrude from the backing plate front surface 120A and through the intermediate plate 115 at its spacing portions 117. The spacer elements 126 along with the spacing portions 117, also acting as the spacer elements, define the liquid accumulating space therebetween. In the examples without the intermediate plate, the pressing layer can rest directly on the spacer elements 126 for thereby being spaced from the backing plate front surface to define the liquid accumulating space between the pressing layer and the backing plate front surface. In such examples, the spacer elements can be separate elements or can be integrally formed with either or both of the backing plate and the pressing layer. In some examples, the spacer elements can constitute a spacer layer with a plurality of spacer elements, either discreet or connected to each other, having spaces therebetween defining the liquid accumulating space.

The mold 100 further comprises fixing mechanism 140 fixing the liquid permeable pressing plate 112 together with the backing plate 120. In the illustrated example, the fixing mechanism 140 includes fixing elements 142 integrally formed and protruding from the spacer elements 126, and recesses 144 formed at the liquid permeable plate 112 at locations corresponding to those of the fixing elements 142. The recesses 144 are configured to receive therewithin the fixing elements 142 to facilitate assembly of the liquid permeable pressing plate 112 with the backing plate 120. In the illustrated example, the fixing elements 142 protrude from the spacer elements 126 and together therewith facilitates assembly of the intermediate layer 115 with the backing plate 120 and the liquid permeable pressing plate 112. In other examples, with or without the intermediate plate, the fixing elements can protrude directly from the backing plate front surface. In some examples, the fixing elements can be integrally formed with and protrude from the liquid permeable pressing plate and the recesses can be formed on the backing plate front surface. In some examples, some fixing elements can protrude from the liquid permeable pressing plate to be received in the corresponding recessed formed on the backing plate front surface and some fixing elements can protrude from the backing plate front surface to be received in the corresponding recessed formed on the liquid permeable pressing plate.

The fixing elements 142 are removably received in the recesses 144, and accordingly the fixing mechanism 140 detachably fixes the liquid permeable pressing plate 112 together with the backing plate 120. In some examples, the fixing elements 142 can be removably received in the recesses 144. It is to be understood herein that in some examples, the fixing mechanism 140 can have any structure, for example other than the one illustrated herein comprising the fixing element 142 and recesses 144, suitable to detachably or fixedly fix the liquid permeable pressing plate 112 together with the backing plate 120.

In the illustrated example, the liquid permeable pressing plate 112 being detachably fixed with the backing plate 120 can be detached therefrom and can be removed from the mold, for example for cleaning purposes. Accordingly, the liquid permeable pressing plate 112 can be effectively cleaned from both sides thereof thereby effectively cleaning the pores of the liquid permeable pressing plate 112 that improves the efficiency of extraction of liquid from the mixture. Further, the mixture can be easily placed onto the detached and removed liquid permeable pressing plate 112, which can subsequently be fed into the mold. On the other hand, after the completion of the process, the liquid permeable pressing plate 112 can be detached and removed from the mold together with the final product, thereby allowing an easy removal of the product from the mold.

The mold 100 further comprises a heating mechanism 150 configured to heat the mixture M during processing thereof. The heating mechanism 150 is configured to produce high temperatures ranging up to 400 DC that also assist in extraction of the liquid from the mixture thereby rendering the processing more efficient. In the illustrated example, the heating mechanism 150 is a fluid heating mechanism comprising heating channels 152 positioned within the backing plate 120 having heating fluid ports 152A and 152B configured for receiving therethrough a heating fluid, such as heated oil. The heating channels 152 can be embedded within or integrally formed with the backing plate 120. The heated oil when flows though the heating channels 152, heats the backing plate 120, which heat is then transferred (conducted) to the first pressing layer 112 and then to the mixture. It is to be understood herein that the heating mechanism 150 can be implemented in all of the general as well as illustrated examples of the molds 1 and 100 described herein in the manner similar to as described with respect to the illustrated example of mold 100. In some examples, the heating mechanism can be any other heating mechanism than a fluid heating mechanism configured to heat the mixture in the manner described above. In some examples, the heating mechanism can be a resistive heating mechanism.

During the above-mentioned processing of the mixture within the mold 100 (and/or mold 1), the mixture M is subjected to high pressures ranging between 60 to 150 bar and temperature ranging between 50 to 140 DC, and at least 8% weight reduction is observed in the mixture due to the liquid loss. In some examples, the mixture M can be subjected to high pressure ranging between 100 to 130 bar and temperature ranging between 90 to 110 DC. In some examples, the mixture M can be subjected to high pressure ranging up to 300 bar and temperature ranging up to 400 DC.

Reference is now made again to FIGS. 1A to 1I to describe various features of the mold 1. It is to be understood herein that although the features described below have been described with respect to the mold 1, all of some of these features can constitute the features of the mold 100, or even any other mold comprising a pressing mechanism and a press member configured to process the mixture. For instance, in some examples, the features described below with respect to biasing mechanism and/or ejection mechanism can relate to any mold comprising a pressing mechanism and press member with or without one or more of liquid permeable pressing layers, capillary fabric, backing plate, liquid accumulating space, intermediate plate, heating mechanism, suction mechanism, drainage channels, capillary fabrics, liquid permeable pressing layers, spacer elements, and fixing mechanism.

In other words, some or all of the features described below with respect to the mold 1 can constitute features of any mold comprising a pressing mechanism configured to receive the mixture to be processed therewithin and press the mixture to extract liquid therefrom and a press member operatively coupled to the pressing mechanism to operate the pressing mechanism to press the mixture. In some examples, the pressing mechanism can comprise the pressing layers having some or all of the features of the pressing layers described above according to the aspect described with reference to FIGS. 2A to 2I and 3A to 3K. In some examples, the mold can have some or all of the features related to one or more of the liquid accumulating space, the backing plate, the intermediate plate, the fixing mechanism, the suction unit, the heating mechanism, and the spacer elements. In the examples without the liquid accumulating space, the liquid can be discharged from the mold in any suitable manner not affecting the operation of the mold.

In the illustrated example, the mold 1 comprises a biasing mechanism 60 operatively coupled to the pressing mechanism 10 and configured to continuously bias the pressing mechanism in a direction to pressurize the mixture to compensate for a pressure drop in the mixture due to extraction of the liquid from the mixture during its processing. It is to be understood herein that the term continuously when used in the context of biasing by the biasing mechanism intends to mean that the biasing mechanism is configured to bias the pressing mechanism even in between the pressing cycles of the press member. For instance, the press member PM operates the pressing mechanism 10 in discrete forces for pressing the pressing mechanism. The biasing mechanism continues the bias on the pressing mechanism even between these discrete forces. The press member PM operates the pressing mechanism 10 with a first pulse of force to press the mixture to a first extent. The mixture loses liquid content as a result of the pressing to the first extent. This loss of liquid causes a pressure drop in the mixture and thus the force experienced by the mixture due to the press member (the press member force) gradually reduces despite the fact that the press member is at its position of applying the first pulse of force. The biasing mechanism continuously biases the pressing mechanism in the direction of pressing the mixture. The biasing force applied by the biasing mechanism compensates for the reduction of the press-member force experienced by the mixture and consequently compensates for the drop in pressure within the mixture due to liquid loss.

The pressing mechanism 10 comprises the first pressing layer 12 and the second pressing layer 12′. In some examples, the pressing layers 12 and 12′can be solid pressing layers non-permeable to the liquid. In the illustrated example, the press member PM is operatively coupled to the upper part 2 of the mold 1 and thus to the second pressing layer 12′and is configured to move the second pressing layer 12′(along with the upper part 2) downwards towards the first pressing layer 12 and upwards away from the first pressing layer 12. In some examples, press member PM can be configured to move the first pressing layer 12. In some examples, the press member can be configured to move both the pressing layers towards and away from each other.

The biasing mechanism 60 comprises springs 62 (two visible in the cross-sectional views of the mold 1 shown in FIGS. 1D, 1F, and 1H) operatively coupled to the first pressing layer 12 via the backing plate 20. In some examples without the backing plate, the springs 62 can be directly coupled to the first pressing layer 12. In some examples, the springs can be positioned between the first pressing layer 12 and the backing plate 20, while being configured to bias the first pressing layer in the similar manner as described according to the illustrated example. In some examples, the biasing mechanism can be any other mechanism configured to move the pressing layers towards each other (by biasing either or both of the pressing layers) in addition to the operation of the press member.

In the illustrated example, the springs 62 bias the first pressing layer 12 in a first direction D1, i.e., upwards. In the examples with the springs coupled to the second pressing layer, or when the mold is used in the inverted manner as described above, the first direction can be downwards. The direction of bias of the springs 62 has to be such that the bias effects the pressing of the mixture within the pressing mechanism 10. The press member PM when moves the second pressing layer 12′ to press on to the mixture M to apply the first discrete pulse of force, the second pressing layer 12′ moves downwards to a first extent and a first distance is achieved between the first pressing layer 12 and the second pressing layer 12′. The press member PM subsequently stops moving the second pressing layer 12′ downwards and this completes the first pulse of force, and the force applied by the press member remains constant thereafter until a next pulse of force applied by the press member PM after a time interval T1. Simultaneously, the above mentioned action of the press member causes the first pressing layer 12 to move downwards such that bottom ends of the springs 62 touch a base 6 of the mold 1 (as seen in FIG. 1F), and the springs 62 are loaded in a second direction D2 opposite the first direction D1, which in the illustrated example is downwards. In the examples with the springs coupled to the second pressing layer, the second direction can be upwards. This loading of the springs causes the springs to bias the first pressing layer 12 upwards, i.e., in the first direction.

During the time interval T1, the mixture loses liquid (at least as a result of the pressing) and thereby experiences a loss in volume and consequently a loss in pressure within the mixture. This loss in pressure is compensated by the spring 62 continuously (i.e., in between the discrete pulses of force applied by the press member) biasing the first pressing layer upwards to reduce the distance between the pressing layers. This action of the springs 62 also results in a final product with uniform physical properties, especially density, throughout.

After time interval T1, the press member PM again moves the second pressing layer downwards repeating the whole sequence, i.e., applying a second pulse of force on the mixture and loading the springs 62 again in the downwards direction. During a time interval T2 until a third pulse of force, the whole sequence repeats, i.e., loss in pressure in the mixture and the pressure being compensated by the springs 62 by continuously biasing the first pressing layer upwards. These sequences are repeated until the final product is obtained.

It is to be understood herein that a biasing mechanism in addition to the press member results in continuous bias of the pressing mechanism in a direction towards pressing the mixture, and thus at no time the mixture is allowed to experience a drop in pressure that could result in non-uniformity in the physical properties in the final product. In addition to the above, the press member PM can as well be controlled by a controller so as to apply forces in order to compensate for the liquid loss from the mixture.

It is to be understood herein that the first direction and the second direction have been described as being upwards and downwards respectively, in the context of the example illustrated in FIGS. 1A to 1I, and in the examples, when the biasing mechanism is configured to bias the pressing layer positioned on top, such as shown in FIG. 4A, the first and second directions would be inverted accordingly.

In the illustrated example, the first pressing layer 12 constitutes a bottom pressing layer and the mold 1 further comprises a frame 8 surrounding a periphery of the first pressing layer 12. In some examples, the frame can surround the first pressing layer partially. The frame 8 has a frame front surface 8A facing in the same direction, a third direction, as the pressing layer front surface 12A. i.e., towards the mixture or in other words, from the pressing layer back surface towards the pressing layer front surface. The mold 1 further comprises an ejecting mechanism 70 configured to position the pressing layer front surface 12A further in the third direction, which is upwards in the illustrated example, than the frame front surface 8A. For instance, in some examples, the ejecting mechanism can be configured to move either or both of the first pressing layer and the frame so as to position the pressing layer front surface further from the frame front surface in the third direction. The pressing layer front surface 12A being placed further from the frame front surface 8A facilitates easy ejection of the final product from the mold 1, especially in examples in which the pressing layer is not removable from the mold. The ejecting mechanism 70 comprises springs 72 coupled to the first pressing layer 12 via the backing plate 20. In the examples without the backing plate, the springs 72 can be directly coupled to the first pressing layer 12. In some examples, the springs 72 can be positioned between the backing plate and the pressing layer to bias the pressing layer in the third direction. In the illustrated example, the ejecting mechanism 70 further comprises springs 74 on which the frame 8 rests. In some examples, the ejecting mechanism can operate without the springs 74. The springs 72 and 74 are so dimensioned and arranged that in the absence of any downward force from the press member, the springs 72 push the pressing layer front surface 12A further from the frame front surface 8A in the upwards direction.

It is to be understood herein that in some examples, the mold may not include the frame and the ejecting mechanism can still bias the pressing layer in the third direction for allowing easy ejection or removal of the final product.

Reference is now made to FIGS. 4A and 4B illustrating a mold 200 (FIG. 4A) according to an example of the presently disclosed subject matter. The mold 200 has some or all of the features corresponding to those of the molds 1 and 100, and is configured to operate in the same manner as mold 1 and/or 100 to process the mixture (for instance, mixture M) to produce article of manufacture (for instance, final product P).

It is to be understood herein that the mold 200 as described below has all the features related to operation of the mold same as those of the molds 1 and 100 as described throughout the present description. For instance, some or all of the features relating to the pressing mechanism, the press member, the pressing layers, the backing plate, the intermediate plate, the liquid accumulating space, the drainage channels, the suction unit and suction channels, the heating mechanism, the fixing mechanism, the spacer elements, the ejecting mechanism, and the processing of the mixture to produce the final product as described with respect to the mold 1 and/or 100 can constitute the features of the mold 200 according to various examples of the presently disclosed subject matter. Thus, all the examples described above with respect to these features of molds 1 and 100 apply mutatis mutandis to those features if and when they constitute the features of mold 200 as well, and their repetition has been avoided for the purposes of preciseness and clarity. The main difference between the mold 200 and molds 1 and/or 100 being that the mold 200 is illustrated as being used in the inverted manner as compared to the molds 1 and 200, and a separating mechanism. The corresponding reference numerals have been used for describing the components of mold 200 as those of molds 1 and 100 for ease of understanding of other examples that are although not shown but are described generally and are within the scope of the presently disclosed subject matter.

The mold 200 has a bottom part 202 and an upper part 204 and comprises a pressing mechanism 210 constituted by a first pressing layer 212 (forming a part of the upper part 204) and a second pressing layer 212′ (forming a part of the bottom part 204). It is to be understood herein that the upper part 204 of the mold 200 corresponds to the bottom parts 4 and 104 of the molds 1 and 100 and can include some or all of the features thereof. Accordingly, the first pressing layer 212 can include some or all of the features of the pressing layer 12 and/or 112. In the illustrated example, a press member PM is operatively coupled to the upper part 204 to move along the pressing direction PD, the upper part 204 towards and away from the bottom part 202, thereby operating the pressing mechanism 210. In some examples, either or both of the upper and bottom parts can be movable towards and away from each other. It is to be understood herein that all of the description with respect to press member PM provided herein above with reference to mold 1 and 100 applies to the press member PM with reference to mold 200 as well.

As can be seen in FIG. 4A, the pressing layer 212 and 212′are arranged perpendicular to the pressing direction PD. In some examples, one or more of the pressing layers can be arranged at an angle between 0 and 90 degrees with respect to the pressing direction PD.

The bottom part 202 includes a second backing plate 220′ (whereas the first backing plate can be the backing plate in the upper part 204 (not shown) and can be corresponding to the backing plate 20 and/or 120). It is to be understood herein that second pressing layer 212′ can include some or all of the features of the pressing layers 12 and/or 112 and the second backing plate 220′ can include some or all of the features of the backing plates 20 and/or 120. Further, some or all of the features of the second pressing layer 212′ can constitute the features of the pressing layers 12 and/or 112 and some or all of the features of the second backing plate 220′ can constitute the features of the backing plates 20 and/or 120.

The bottom part 202 together with the final product P has been shown in exploded view in FIG. 4B, according to an example of the presently disclosed subject matter. In the illustrated example, the bottom part 202 comprises a separating mechanism 280 separating the second pressing layer 212′ from the second backing plate 220′, thereby maintaining a gap G between a portion 213′ (which in the illustrated example is the periphery of the second pressing layer 212′) of the second pressing layer 212′ and a portion 221′ (which in the illustrated example is the periphery of the second backing plate 220′) of the second backing plate 220′. The gap G allows a user to get hold of the second pressing layer 212′ to detach it from the second backing plate 220′ and to remove it from the mold 200, either alone (for cleaning and placing the mixture thereon) or together with the product P (after processing).

The second pressing layer 212′ has a second pressing layer front surface 212′A and an opposite second pressing layer back surface 212′B facing the second backing plate 220′, and the second backing plate 220′ has a second backing plate front surface 220′A facing the second pressing layer 212′ and an opposite second backing plate back surface 220′B. A liquid accommodating space 230′ is formed between the second pressing layer back surface 212′B and the second backing plate back surface 220′B. It is to be understood herein that the liquid accommodating space 230′ can be realized in any manner described herein according to various examples with respect to the liquid accumulating space 30 and/or 130, and their corresponding description applies to the liquid accumulating space 230′ as well. In the illustrated example, the separating mechanism 280 comprises springs 282 (two shown in the illustrated example, although any number of springs 282 can be used) positioned between the second pressing layer 212′ and the second backing plate 220′. The springs 282 bias the second pressing layer 212′ in a direction extending from the second backing plate 220′ towards the second pressing layer 212′, i.e., away from the second backing plate 220′. During the operation of the mold 200, when the upper part 204 and the bottom part 202 are pressed together, the gap G is reduced (for example to zero or to any value being its minimum value), thereby sealing the liquid accumulating space 230′ from the peripheries of the second pressing layer 212′ and the second backing plate 220′. When the upper part and bottom part are moved away from each other, for example after processing of the mixture is complete to form the final product P, the springs 282 cause the second pressing layer 212′ to be separated from the second backing plate 220′ at least enough to result in the gap G therebetween.

Although the fixing mechanism has not been illustrated in FIGS. 4A and 4B, it is to be understood that the second pressing layer 212′ and the second backing plate 220′ can be fixed to each other by any fixing mechanism, for example one corresponding to the fixing mechanism 140, whereas the fixing elements are received in the recesses during the pressing of the upper part and bottom part together, and at least partially come out of the recesses (for example, by virtue of the separating mechanism) when the upper part and bottom part are moved away from each other.

The second pressing layer 212′ can be removed from the mold 200 for cleaning purposes or to effectively position the mixture thereupon and remove the product therefrom. The second pressing layer 212′ after being removed from the mold, can be cleaned from both sides thereby rendering the liquid extraction more efficient.

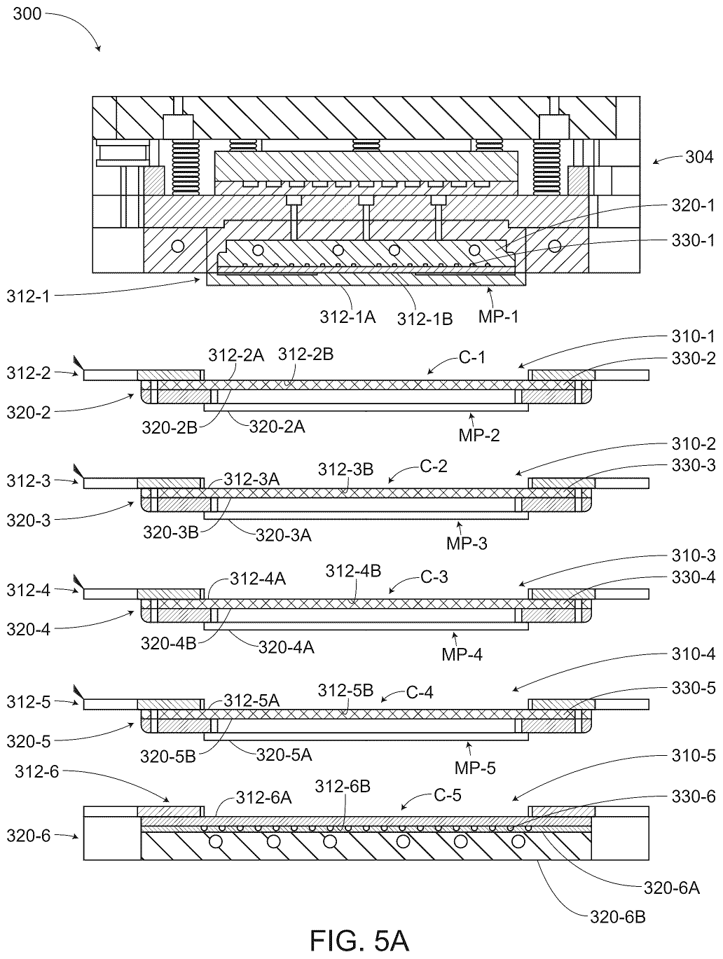

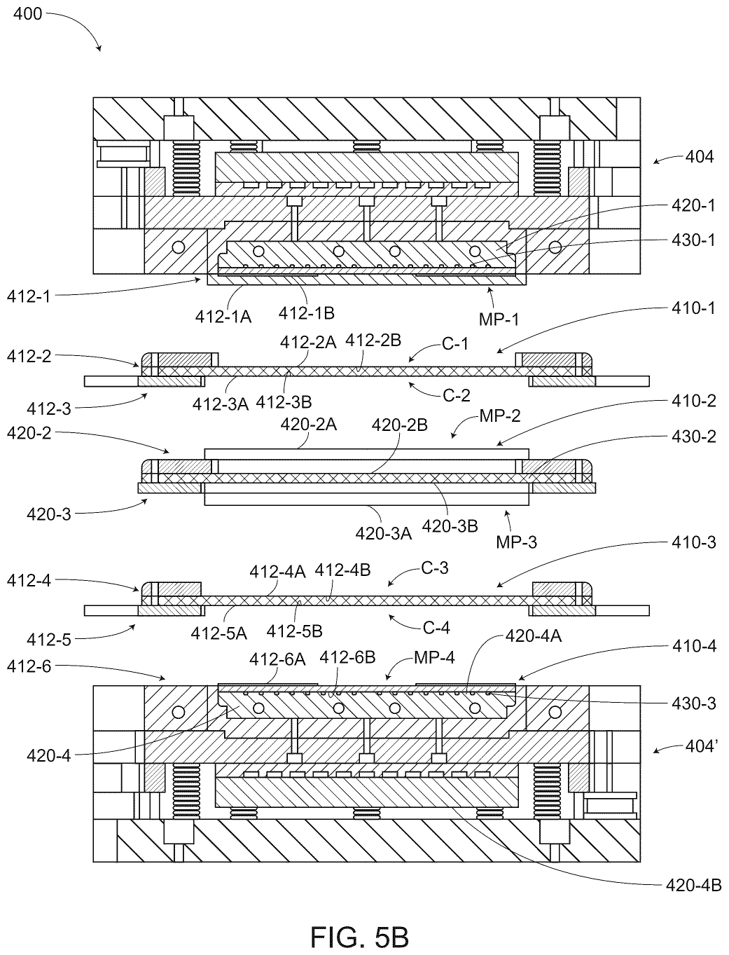

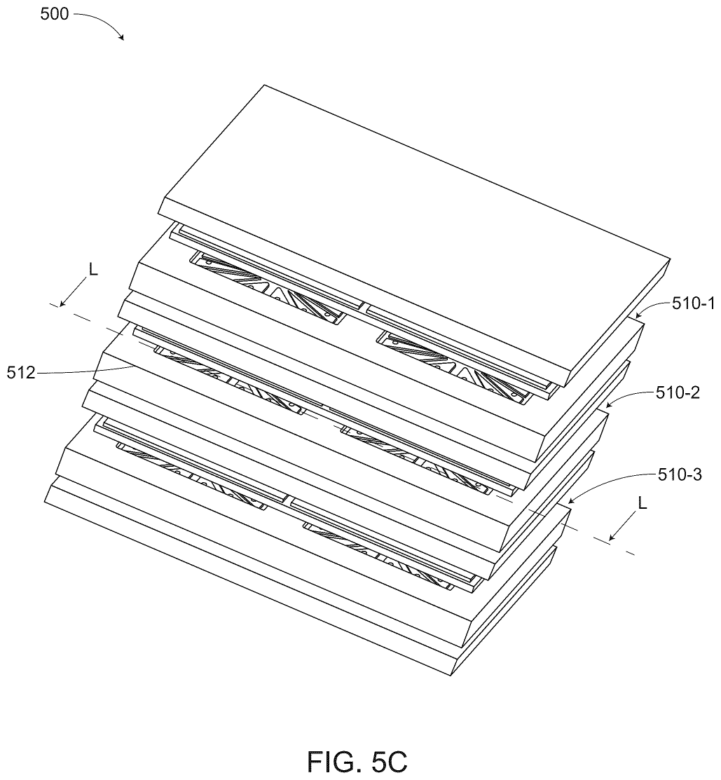

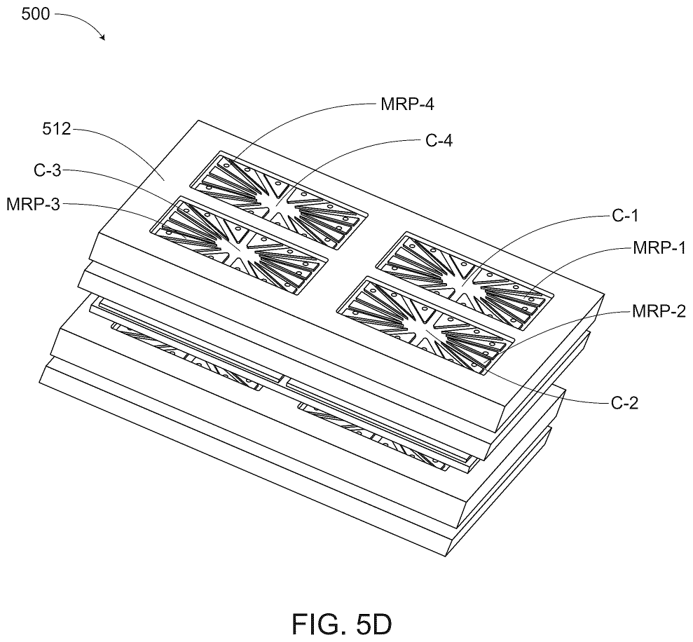

The second pressing layer 212′ includes a mixture receiving portion MRP, which in the illustrated example, is the cavity C for receiving thereupon the mixture. The cavity C ensures a proper placement and positioning of the mixture on the second pressing layer 212′, and that the product P is reliably held in the therewithin during removal of the second pressing layer 212′ from the mold. In some examples, the second pressing layer 212′ (or in fact any of the pressing layers described herein) can include more than one mixture receiving portions (for example, as shown in the example illustrated in FIGS. 5C and 5D), whether in the form of cavity or plane surface.

It is to be understood herein that, the features of the bottom part 202 described herein, for example with respect to the separating mechanism and/or the cavity C, can constitute the features of the either or both of the upper part and bottom part of the molds 1 and/or 100. In some examples, the biasing mechanism 60, the ejecting mechanism 70 and the separating mechanism 280 can be realized as a single mechanism performing the operations of all of these mechanisms. For instance, one or more springs (or other equivalent biasing elements) can be arranged to bias the pressing layer in a direction extending from a back surface thereof towards a front surface (the surface for engaging the mixture) thereof. Such one ore more springs can be configured (positioned, oriented, and/or dimensioned) to serve the purposes of the biasing mechanism, ejecting mechanism, and/or the separating mechanism as described herein.

Reference is now made to FIG. 5A illustrating, at least partially schematically, a mold 300 according to an example of the presently disclosed subject matter. The mold 300 has some or all of the features corresponding to those of the molds 1, 100, and 200, and is configured to operate in the same manner as mold 1, 100 and/or 200 to process the mixture (for instance, mixture M) to produce article of manufacture (for instance, final product P).

It is to be understood herein that the mold 300 as described below has all the features related to operation of the mold same as those of the molds 1, 100, and 200 as described throughout the present description. For instance, some or all of the features relating to the pressing mechanism, the press member, the pressing layers, the backing plate, the intermediate plate, the liquid accumulating space, the drainage channels, the suction unit and suction channels, the heating mechanism, the fixing mechanism, the spacer elements, the ejecting mechanism, the separating mechanism, and the processing of the mixture to produce the final product as described with respect to the mold 1, 100, and/or 200 can constitute the features of the mold 300 according to various examples of the presently disclosed subject matter. Thus, all the examples described above with respect to these features of molds 1, 100 and 200 apply mutatis mutandis to those features if and when they constitute the features of mold 300 as well, and their repetition has been avoided for the purposes of preciseness and clarity. The main difference between the mold 300 and molds 1, 100, and/or 200 being that the mold 300 comprises more than pressing mechanisms and more than one mixtures (or more than one portions of the same mixture) can be processed simultaneously in the mold 300. The corresponding reference numerals have been used for describing the components of mold 300 as those of molds 1, 100 and 200 for ease of understanding of other examples that are although not shown but are described generally and are within the scope of the presently disclosed subject matter.

The mold 300 has an upper part 304 corresponding to the upper part 204 of the mold 200 and all the description thereof applies to the upper part 304 of the mold 300 as well. The mold 300 further includes a first pressing mechanism 310-1 for receiving and processing a first mixture, a second pressing mechanism 310-2 for receiving and processing a second mixture, a third pressing mechanism 310-3 for receiving and processing a third mixture, a fourth pressing mechanism 310-4 for receiving and processing a fourth mixture, and a fifth pressing mechanism 310-5 for receiving and processing a fifth mixture. It is to be understood herein that any number of pressing mechanisms and their corresponding components described herein below can be included in a mold according to various examples of the presently disclosed subject matter. It is to be understood herein that the first, second, third, fourth, and fifth mixtures can be different mixtures or can be different portions of the same mixture.

The mold 300 includes a first pressing layer 312-1 and first backing plate 320-1 corresponding respectively to the pressing layer 12, 112, or 212 and the backing plates 20 or 120 and can include some or all of the features thereof. The first pressing layer has a first pressing layer front surface 312-1A for engaging the first material and an opposite first pressing layer back surface 312-1B. The mold further incudes a second pressing layer 312-2 having a second pressing layer front surface 312-2A for engaging the first mixture and an opposite second pressing layer back surface 312-2B, a third pressing layer 312-3 having a third pressing layer front surface 312-3A for engaging the second mixture and an opposite third pressing layer back surface 312-3B, a fourth pressing layer 312-4 having a fourth pressing layer front surface 312-4A for engaging the third mixture and an opposite fourth pressing layer back surface 312-4B, a fifth pressing layer 312-5 having a fifth pressing layer front surface 312-5A for engaging the fourth mixture and an opposite fifth pressing layer back surface 312-5B, and a sixth pressing layer 312-6 having a sixth pressing layer front surface 312-6A for engaging the fifth mixture and an opposite fifth pressing layer back surface 312-6B.

It is to be understood herein that one or more of the first, second, third, fourth, fifth, and sixth pressing layers can include some or all of the features of any of the pressing layers described herein. For instance, one or more of the first, second, third, fourth, fifth, and sixth pressing layers can have a corresponding backing plate and a corresponding liquid accumulating space, according to any of the examples thereof described herein.

In the illustrated example, the mold 300 incudes a second backing plate 320-2 having a second backing plate front surface 320-2A facing the second pressing layer 312-2 and an opposite second backing plate back surface 320-2B, a third backing plate 320-3 having a third backing plate front surface 320-3A facing the third pressing layer 312-3 and an opposite third backing plate back surface 320-3B, a fourth backing plate 320-4 having a fourth backing plate front surface 320-4A facing the fourth pressing layer 312-4 and an opposite fourth backing plate back surface 320-4B, a fifth backing plate 320-5 having a fifth backing plate front surface 320-5A facing the fifth pressing layer 312-5 and an opposite fifth backing plate back surface 320-5B, and a sixth backing plate 320-6 having a sixth backing plate front surface 320-6A facing the sixth pressing layer 312-6 and an opposite sixth backing plate back surface 320-6B.

It is to be understood herein that one or more of the first, second, third, fourth, fifth, and sixth backing plates can include some or all of the features of any of the backing plates described herein. One or more of the combinations of the first, second, third, fourth, fifth, and sixth pressing layers and corresponding backing plates can have a corresponding liquid accumulating space therebetween, according to any of the examples thereof described herein.

In the illustrated example, each of the second, third, fourth, fifth, and sixth pressing layers 312-2 to 312-6 have cavities C-1, C-2, C-3, C-4, C-5, and C-6 respectively to receive the corresponding mixtures therewithin and each of the first pressing layer 312-1 and second, third, fourth, and fifth backing plates 320-2 to 320-5 have male punch members MP-1, MP-2, MP-3, MP-4, and MP-5 to enter into the respective cavity for pressing the material therewithin. It is to be understood herein that in some examples, the one or more of the second to sixth pressing layers may not include the cavity and/or one or more of the first pressing layer and second to fifth backing plates may not include the male punch member.

In the illustrated example, the mold 300 incudes a first liquid accumulating space 330-1 between the first pressing layer 312-1 and the first backing plate 320-1, a second liquid accumulating space 330-2 between the second pressing layer 312-2 and the second backing plate 320-2, a third liquid accumulating space 330-3 between the third pressing layer 312-3 and the third backing plate 320-3, a fourth liquid accumulating space 330-4 between the fourth pressing layer 312-4 and the fourth backing plate 320-4, a fifth liquid accumulating space 330-5 between the fifth pressing layer 312-5 and the fifth backing plate 320-5, and a sixth liquid accumulating space 330-6 between the sixth pressing layer 312-6 and the sixth backing plate 320-6.

In some examples, one or more of the liquid accumulating spaces can be in fluid communication with one or more of the remaining liquid accumulating spaces, thereby increasing the overall efficiency of the liquid accumulation of the mold 300.

The mold 300 can include a press member (not shown) to simultaneously operate the pressing mechanisms 310-1 to 310-5. The press member can include some or all of the features of the press member PM described herein, and additionally can include support members to support each of the pressing mechanisms and their corresponding components. In some examples, the mold 300 can include a support mechanism separate from the press member to support each of the pressing mechanisms and their corresponding components. Although the support mechanism is not shown in the schematic illustration of the mold 300, it is to be understood herein that the support mechanism can have any structure generally known in the art to support multiple pressing mechanisms in a single mold, for example muti-stacking mold.

In the illustrated example, the first pressing mechanism 310-1 is constituted by the first pressing layer front surface 312-1A and the second pressing layer front surface 312-2A, the second pressing mechanism 310-2 is constituted by the second backing plate back surface 320-2B and the third pressing layer front surface 312-3A, the third pressing mechanism 310-3 is constituted by the third backing plate back surface 320-3B and the fourth pressing layer front surface 312-4A, the fourth pressing mechanism 310-4 is constituted by the fourth backing plate back surface 320-4B and the fifth pressing layer front surface 312-5A, and the fifth pressing mechanism 310-5 is constituted by the fifth backing plate back surface 320-5B and the sixth pressing layer front surface 312-6A.

Each combination of the two surfaces constituting a pressing mechanism correspond to a front and back side of the final product to be produced in the pressing mechanism. In the illustrated example, all the pressing layer front surfaces face in a single direction, however, in some examples (such as one shown in FIG. 5B), the pressing layer front surfaces or alternating pressing layers can face in opposite directions.

Reference is now made to FIG. 5B illustrating, at least partially schematically, a mold 400 according to an example of the presently disclosed subject matter. The mold 400 has some or all of the features corresponding to the mold 300 and all the description provided above with respect thereto applies mutatis mutandis to the mold 400 as well.

The mold 400 has an upper part 404 corresponding to the upper part 304 of the mold 300 and all the description thereof applies to the upper part 404 of the mold 400 as well. The mold 400 has a bottom part 404′ corresponding to the upper part 404 or to the 304 of the mold 300 and all the description thereof applies to the bottom part 404′ of the mold 400 as well. The mold 400 further includes a first pressing mechanism 410-1 for receiving and processing a first mixture, a second pressing mechanism 410-2 for receiving and processing a second mixture, a third pressing mechanism 410-3 for receiving and processing a third mixture, and a fourth pressing mechanism 410-4 for receiving and processing a third mixture. It is to be understood herein that any number of pressing mechanisms and their corresponding components described herein below can be included in a mold according to various examples of the presently disclosed subject matter. It is to be understood herein that the first, second, third, and fourth mixtures can be different mixtures or can be different portions of the same mixture.

The mold 400 includes a first pressing layer 412-1 and first backing plate 420-1 corresponding respectively to the pressing layer 312-1 and the backing plate 320-1 and can include some or all of the features thereof, and all the description thereof applies to the first pressing layer 412-1 and first backing plate 420-1 as well. The first pressing layer 412-1 has a first pressing layer front surface 412-1A for engaging the first material and an opposite first pressing layer back surface 412-1B. The mold further incudes a second pressing layer 412-2 having a second pressing layer front surface 412-2A for engaging the first mixture and an opposite second pressing layer back surface 412-2B, a third pressing layer 412-3 having a third pressing layer front surface 412-3A for engaging the second mixture and an opposite third pressing layer back surface 412-3B, a fourth pressing layer 412-4 having a fourth pressing layer front surface 412-4A for engaging the third mixture and an opposite fourth pressing layer back surface 412-4B, a fifth pressing layer 412-5 having a fifth pressing layer front surface 412-5A for engaging the fourth mixture and an opposite fifth pressing layer back surface 412-5B, and a sixth pressing layer 412-6 having a sixth pressing layer front surface 412-6A for engaging the fourth mixture and an opposite fifth pressing layer back surface 412-6B.

It is to be understood herein that one or more of the first, second, third, fourth, fifth, and sixth pressing layers can include some or all of the features of any of the pressing layers described herein. For instance, one or more of the first, second, third, fourth, fifth, and sixth pressing layers can have a corresponding backing plate and a corresponding liquid accumulating space, according to any of the examples thereof described herein.

In the illustrated example, the mold 400 incudes a second backing plate 420-2 having a second backing plate front surface 420-2A facing the third pressing layer 412-3 and an opposite second backing plate back surface 420-2B, a third backing plate 420-3 having a third backing plate front surface 420-3A facing the fourth pressing layer 412-3 and an opposite third backing plate back surface 420-3B, and a fourth backing plate 420-4 having a fourth backing plate front surface 420-4A facing the sixth pressing layer 412-6 and an opposite fourth backing plate back surface 420-4B.

It is to be understood herein that one or more of the first, second, third, and fourth backing plates can include some or all of the features of any of the backing plates described herein.

In the illustrated example, each of the second, third, fourth, and fifth pressing layers 412-2 to 412-5 have cavities C-1, C-2, C-3, C-4, and C-5 respectively to receive the corresponding mixtures therewithin and each of the first pressing layer 412-1, the second and third backing plates 320-2 and 320-3, and the sixth pressing layer 412-6 have male punch members MP-1, MP-2, MP-3, and MP-4 to enter into the respective cavity for pressing the material therewithin. It is to be understood herein that in some examples, the one or more of the second to fifth pressing layers may not include the cavity and/or one or more of the first pressing layer, the second and third backing plates and the sixth pressing layer may not include the male punch member.

In the illustrated example, the mold 400 incudes a first liquid accumulating space 430-1 between the first pressing layer 412-1 and the first backing plate 420-1, a second liquid accumulating space 430-2 between the second backing plate 420-2 and the third backing plate 420-3, and a third liquid accumulating space 430-3 between the sixth pressing layer 412-6 and the fourth backing plate 420-4.

In some examples, one or more of the liquid accumulating spaces can be in fluid communication with one or more of the remaining liquid accumulating spaces, thereby increasing the overall efficiency of the liquid accumulation of the mold 400.

The mold 400 can include a press member (not shown) to simultaneously operate the pressing mechanisms 410-1 to 410-4. The press member can include some or all of the features of the press member PM described herein, and additionally can include support members to support each of the pressing mechanisms and their corresponding components. In some examples, the mold 400 can include a support mechanism separate from the press member to support each of the pressing mechanisms and their corresponding components. Although the support mechanism is not shown in the schematic illustration of the mold 400, it is to be understood herein that the support mechanism can have any structure generally known in the art to support multiple pressing mechanisms in a single mold, for example muti-stacking mold.

In the illustrated example, the first pressing mechanism 410-1 is constituted by the first pressing layer front surface 412-1A and the second pressing layer front surface 412-2A, the second pressing mechanism 410-2 is constituted by the third pressing layer front surface 412-3A and the second backing plate front surface 420-2A, the third pressing mechanism 410-3 is constituted by the third backing plate front surface 420-3A and the fourth pressing layer front surface 412-4A, and the fourth pressing mechanism 410-4 is constituted by the fifth pressing layer front surface 412-5A and the sixth pressing layer front surface 412-6A.

Each combination of the two surfaces constituting a pressing mechanism correspond to a front and back side of the final product to be produced in the pressing mechanism. In the illustrated example, the first, third, and fifth pressing layer front surfaces face in one direction, and the second, fourth, and sixth pressing layer front surfaces face in opposite direction. In other words, the alternating pressing layers front surfaces face in opposite directions.

FIGS. 5C and 5D illustrate an arrangement 500A of pressing mechanisms of a mold 500 according to another example of the presently disclosed subject matter. The pressing mechanisms and arrangement thereof in the mold 500 correspond to the pressing mechanisms and their arrangement in the mold 300, with the only difference being that each of the pressing layers of the mold 500 comprise more than one (four, in the illustrated example) mixture receiving portions, all formed as cavities.

For instance, the mold 500 includes three pressing mechanisms 510-1, 510-2, and 510-3 each corresponding to the pressing mechanisms of the mold 300. As can be seen the best in FIG. 5D, the pressing mechanism 510-2 is at least partially constituted by a pressing layer, generally designated as 512, including four mixture receiving portions MRP-1, MRP-2, MRP-3, and MRP-4, which in the illustrated example, are formed as cavities C-1, C-2, C-3, and C-4 respectively. It is to be understood herein that some or all of the pressing layers described herein can include any number of mixture receiving portions, some or all of them being formed as cavities. Accordingly, such pressing layers can be used to press multiple mixtures (or multiple portions of the same mixture) in a single pressing layer. Accordingly, a mold according to some examples, can include multiple pressing mechanisms having pressing layers with multiple mixture receiving portions thereby increasing the overall efficiency of the mold.

Reference is now made to FIGS. 6A to 6C illustrating a mold 600 according to an example of the presently disclosed subject matter. The mold 600 comprises a pressing mechanism 610 corresponding to any one of the pressing mechanisms described herein according to various examples. The pressing mechanism 610 is operated by a press member PM in the pressing direction PM. It is to be understood herein that the PM corresponds to the press member PM described herein above with respect to molds 1 to 500, and corresponding description thereof applies to the press member PM of the mold 600 as well. In the example illustrated in FIGS. 6A to 6C, the press member does not move the pressing mechanism 610 or any of the pressing layers and/or the backing plates but instead presses the mixture onto the pressing layers. As can be seen in FIG. 6A, the mold 600 comprises various mechanisms for operating the mold 600 for performing various functions, and all such mechanisms have been collectively referred to herein as operational mechanisms OM and are not directly related to the aspects of the presently disclosed subject matter, and have not been described in detail herein for the purposes of conciseness of the present description.

As can be best seen in FIG. 6C, the mold 600 comprises a first pressing layer 612-1, a second pressing layer 612-2, a third pressing layer 612-3, and a fourth pressing layer 612-4, constituting at least partially the pressing mechanism 610, and arranged to define two mixture receiving spaces S, first space S between the first and third pressing layers 612-1 and 612-3 and second space S between the second and fourth pressing layers 612-2 and 612-4. A mixture to be processed in the mold 600 can be positioned in the spaces S and the press member PM can be operated from the top to press the mixture at least partially against the pressing layers 612-1 to 612-4 along with pressing along top and bottom walls W defining the spaces S.

As can be seen in FIGS. 6B and 6C, the pressing layers 612-1 to 612-4 are arranged parallel to the pressing direction PD, unlike the examples of the molds 1 to 500 where the pressing layers are arranged perpendicular to the pressing direction. In some examples, one or more of the pressing layers 612-1 to 612-4 can be arranged at an angle between 0 and 90 degrees with respect to the pressing direction PD.

It is to be understood herein that one or more of the pressing layers 612-1 to 612-4 can include some or all of the features of any of the pressing layers described herein above with respect to the molds 1 to 500. For instance, in general, one or more of the 612-1 to 612-4 can be liquid permeating layers, while others may not be liquid permeating layers.

In the illustrated example, all of the pressing layers 612-1 to 612-4 are liquid permeable layers, and the mold 600 includes a first backing plate 620-1 associated with the first pressing layer 612-1, a second backing plate 620-2 associated with the second pressing layer 612-2, and a third backing plate 620-3 associated with the third pressing layer 612-3 and fourth pressing layer 612-4 and positioned therebetween. It is to be understood herein that one or more of the backing plates 620-1 to 620-3 can include some or all of the features of any of the backing plates described herein above with respect to the molds 1 to 500.

In the illustrated example, the backing plates 620-1 to 620-3 include the liquid accumulating spaces 630-1, 630-2, and 630-3, respectively. It is to be understood herein that one or more of the liquid accumulating spaces 630-1, 630-2, and 630-3 can be realized in any manner as described with respect to various examples the liquid accumulating spaces provided herein. The liquid can be drained from the liquid accumulating spaces 630-1, 630-2, and 630-3 by any suitable drainage arrangement according to any of the examples described herein. It is to be understood herein that in all the examples of the molds including the backing plate, the backing plate can be rigid enough to support the pressing layer for pressing the mixture. The backing plate can be made of a rigid metal, that can be easily heated and does not corrode. One example of such a metal is SS 316L. The backing plate can have rigidity at least measuring 180 Gpa.

It is to be understood herein that in all the examples with the pressing layers being liquid permeable pressing plates comprising pores configured to allow the liquid to permeate therethrough, the pores can have filtering capability of 2 microns particles. In some examples, the liquid permeable pressing plate can be a porosive plate. The porosity size may not exceed microns grade which is X5-X10 times larger than the smallest powder D50 size, and can depend on the flowability of the wetted powder (depends on water/powder ratio, plasticizers, morphology of the powders). In some examples, the porosity grade can be lesser than X5, or even lesser than X2. The porosive plates can be made from sintered metal or any other technique that provides open porosity from both sides. Any type of metal can be suited for the creation of the porosive plate. In some examples, additional types of materials can be used such as ceramic porosive plates or others that can withstand the heat and pressure applied to the mold. Some examples of such materials include SS 316, Inconel 600, Hastelloy X, Monel 400. The liquid permeable pressing plate is rigid enough to press the mixture at least while being supported by the backing plate. In some examples, the liquid permeable pressing plate can have rigidity of at least 10 GPa.

In the examples with the capillary fabric in addition to the liquid permeable pressing plate, the porosity grade can be increased to more than 20 microns. The capillary fabric uses capillary forces to draw out liquid from the mixture. In some examples, the capillary fabric can be multifilament fabrics (can be woven or knitted or non-woven) that can function under heat of at least up to 140 DC, or up to 400 DC. The fibres constructing the fabric can be plant based, polymeric, ceramic, or other that can withstand the heat and the abrasion of the mixture during the processing thereof. In some examples, the capillary fabric can include Polyamide or Polyester with GSM<200.

It is to be understood herein that in some or all examples of the molds described above, the second pressing layer can incorporate some or all of the features that have been described with respect to the first pressing layer according to various examples of the first pressing layer.

1.-136. (canceled)

137. A mold for producing an article of manufacture from a mixture comprising liquid, said mold comprising:
a pressing layer having a pressing layer front surface configured to press the mixture and extract the liquid therefrom, and an opposite pressing layer back surface;
a backing plate having a backing plate front surface facing the pressing layer back surface and an opposite backing plate back surface; and
a liquid accumulating space extending at least partially in a plane parallel to the pressing layer and positioned between the backing plate back surface and the pressing layer front surface, the liquid accumulating space being constituted at least partially by one or more liquid accumulating channels formed as trenches configured to accumulate the liquid therein.

138. The mold according to claim 137, wherein the pressing layer is a liquid permeable pressing layer comprising a plurality of pores to allow the liquid to permeate through the liquid permeable pressing layer, wherein a combined cross-sectional area of the pores at a cross-section taken parallel to the pressing layer front surface is smaller than a cross-sectional area of the liquid accumulating space at a cross-section taken parallel to the pressing layer front surface.

139. The mold according to claim 137, wherein the liquid accumulating space extends under at least a majority of area of the pressing layer front surface.

140. The mold according to claim 137, wherein the liquid accumulating space extends over at least a majority of area of the backing plate back surface.

141. The mold according to claim 137, wherein the liquid accumulating space constitutes a part of at least one of the backing plate and the pressing layer.

142. The mold according to claim 137, wherein the one or more liquid accumulating channels are formed on at least one of the backing plate front surface and the pressing layer back surface.

143. The mold according to claim 137, further comprising an intermediate plate positioned between the backing plate and the pressing layer, wherein the liquid accumulating space is constituted at least partially by one or more liquid accumulating channels formed on the intermediate plate.

144. The mold according to claim 137, wherein the backing plate and the pressing layer are spaced from each other to at least partially define therebetween the liquid accumulating space.

145. The mold according to claim 144, further comprising one or more spacer elements positioned at least partially within the liquid accumulating space.

146. The mold according claim 137, further comprising one or more drainage channels in fluid communication with the liquid accumulating space for draining out the liquid therefrom.

147. The mold according to claim 146, wherein at least one of the one or more drainage channels is at least partially positioned within the backing plate.

148. The mold according to claim 137, further comprising a fixing mechanism for fixing the backing plate and the pressing layer together with each other.

149. The mold according to claim 137, further comprising a separating mechanism for separating the pressing layer from the backing plate.

150. The mold according to claim 149, wherein the separating mechanism is configured to maintain a gap between at least a portion of the pressing layer and at least a portion of the backing plate, thereby separating the pressing layer from the backing plate, at least prior to initiation of operation of the mold and at least after completion of operation of the mold.

151. The mold according to claim 137, further comprising a heating mechanism configured to heat the mixture and assist in the extraction of the liquid.

152. The mold according to claim 151, wherein the heating mechanism is configured to heat the pressing layer.

153. The mold according to claim 151, wherein the heating mechanism is at least partially positioned within the backing plate.

154. The mold according to claim 137, further comprising a suction mechanism in fluid communication with the liquid accumulating space and configured to assist in drainage of liquid therefrom.

155. The mold according to claim 137, wherein the pressing layer comprises a first capillary fabric configured to contact the mixture for absorbing the liquid therefrom and delivering the liquid to the liquid accumulating space.

156. The mold according claim 137, further comprising an ejecting mechanism configured to bias the pressing layer towards a third direction extending from the pressing layer back surface towards the pressing layer front surface.
